(19) United States
(12) Patent Application Publication
(10) Pub. No.: US 2025/0371596 A1
(43) Pub. Date: Dec. 4, 2025

(54) SYSTEMS AND METHODS FOR IMPROVING EFFICIENCY OF PRODUCT SEARCH

(71) Applicant: PARTIUM TECHNOLOGIES GMBH, Vienna (AT)

(72) Inventors: Tomasz ADAMEK, Barcelona (ES); Esteve CERVANTES MARTÍN, Barcelona (ES); Miquel FERRARONS BETRIAN, Barcelona (ES); Philipp GEBHARD, Vienna (AT); Tomas KAZMAR, Vienna (AT); Raphael PISONI, Traunkirchen (AT)

(73) Assignee: PARTIUM TECHNOLOGIES GMBH, Vienna (AT)

(21) Appl. No.: 18/877,683

(22) PCT Filed: Jun. 23, 2023
(86) PCT No.: PCT/IB2023/056529

§ 371 Date: Dec. 20, 2024

Related U.S. Application Data
(60) Provisional application No. 63/354,841, filed on Jun. 23, 2022.

(51) Int. Cl. G06Q 30/0601; G06F 40/169; G06T 7/10

(52) U.S. Cl. CPC G06Q 30/0625; G06F 40/169; G06T 7/10

(57) ABSTRACT

A products search methodology can include receiving a first search query associated with searching products, the first search query having a first set of modalities, generating matches based on a cross-modal search using a machine learning model trained to search for matches in a products catalog that match the first search query, wherein matches in the products catalog have a second set of modalities, receiving an indication that one or more of the matches from the products catalog is a confirmed match to the first search query, responsive to receiving the indication, extracting embeddings, based on a neural network, of at least one modality of the first set of modalities of the first search query, and updating the one or more matches from the products catalog with at least one of the extracted embeddings and the first search query.

### CROSS-REFERENCE TO RELATED APPLICATIONS

This application claims priority to U.S. Provisional Application No. 63/354,841, entitled “Systems and Methods for Improving Efficiency of Product Search,” filed Jun. 23, 2022. The subject matter of the above application is incorporated by reference herein in its entirety.

### TECHNICAL FIELD

This disclosure relates to, product search computing systems and methods, and in particular to improving efficiency of product search based on cross-modal and multi-modal search.

### BACKGROUND

Search for products in catalogs can be carried out by a search system that receives search queries from a user and retrieves results from a products catalog that match the search queries. The search system can rank the results based on certain criteria such that the closest matches from the results are provided first to the user.

### SUMMARY

In some aspects, the techniques described herein relate to a method, including: receiving a first search query associated with searching products, the first search query having a first set of modalities; generating matches based on a cross-modal search using a machine learning model trained to search for matches in a products catalog that match the first search query, wherein matches in the products catalog have a second set of modalities; receiving an indication that one or more of the matches from the products catalog is a confirmed match to the first search query; responsive to receiving the indication, extracting embeddings, based on a neural network, of at least one modality of the first set of modalities of the first search query; updating the one or more matches from the products catalog with at least one of the extracted embeddings and the first search query; receiving a second search query associated with searching products; and generating matches based on a cross-modal search using the machine learning model trained to search for matches in the products catalog that has been updated with the extracted embeddings and the first search query.

In some aspects, the techniques described herein relate to a method, wherein the first set of modalities includes a text modality and an image modality.

In some aspects, the techniques described herein relate to a method, wherein the first set of modalities includes an image modality, and the second set of modalities includes a text modality, and wherein the extracting embeddings includes extracting embeddings of the image modality of the first search query.

In some aspects, the techniques described herein relate to a method, wherein the first set of modalities and the second set of modalities are distinct.

In some aspects, the techniques described herein relate to a method, wherein the first set of modalities includes text modality, the method further including: annotating text of the first search query with structuring information related to the one or more matches in the product catalog prior to updating the one or more matches from the products catalog with the extracted embeddings.

In some aspects, the techniques described herein relate to a method, wherein the first set of modalities includes image modality, the method further including: segmenting, based on a neural network, portions of at least one image included in the first search query that include products, cropping the at least one image to segmented portions of the at least one image prior to extracting embeddings.

In some aspects, the techniques described herein relate to a method, wherein the first set of modalities include image modality, the method further including: determining, using an image matching neural network, a similarity score for the image modality of the search query with respect to each of a plurality of images associated with the one or more matches satisfies a criterion indicating that the image modality is dissimilar; and storing the image modality of the search query in the products catalog in association with the one or more matches.

In some aspects, the techniques described herein relate to a method, wherein the first set of modalities include image modality, the method further including: determining that a quality measure based on at least one of image blur, image noise, or compression artifacts, of the image modality of the search query satisfies a criterion; and storing the image modality of the search query in the products catalog in association with the one or more matches.

In some aspects, the techniques described herein relate to a method, wherein the first set of modalities include image modality, the method further including: identifying a number of regions within an image associated with the image modality; determining a first number of regions within the number of regions that include edges and a second number of regions within the number or regions that do not include edges; storing the image modality of the search query in the products catalog in association with the one or more matches based on a determination that a ratio of the first number of regions to the second number of regions is greater than a threshold value.

In some aspects, the techniques described herein relate to a method, wherein the first set of modalities includes image modality, the method further including: determining, based on image matching or cross-modal matching, a set of data, including texts or images, in the products catalog that most similar to the image modality; determining semantic similarities between members of the set of data; determining at least one statistic including mean or standard deviation of the semantic similarities; storing the image modality of the search query in the products catalog in association with the one or more matches based on a determination that the at least one statistic satisfies a criterion.

In some aspects, the techniques described herein relate to a method, wherein the criterion is a function of a number of images in the products catalog associated with the one or more matches.

In some aspects, the techniques described herein relate to a method, wherein the first set of modalities includes text modality, the method further including: determining a novelty score for the text modality, the novelty score based on comparison of the text modality with text stored in the products catalog in association with the one or more matches; storing the text modality of the search query in the products catalog in association with the one or more matches based on a determination that the novelty score is greater than a threshold value.

In some aspects, the techniques described herein relate to a method, wherein the first set of modalities includes image modality, the method further including: extracting embeddings, based on the neural network, of the image modality; and adding the embeddings of the image modality to pre-existing embeddings of other images associated with the one or more matches.

In some aspects, the techniques described herein relate to a method, wherein the first set of modalities includes a combination of image modality and text modality and wherein for the one or more matches, the products catalog includes a pre-existing single multi-modal embedding, the method further including: extracting text embeddings corresponding to the text modality and extracting image embeddings corresponding to the image modality, adding the text embeddings and the image embeddings to the pre-existing single multi-modal embeddings of associated with the one or more matches.

In some aspects, the techniques described herein relate to a method, wherein for the one or more matches, the products catalog includes a plurality of multi-modal embeddings, each multi-modal embedding of the plurality of multi-modal embedding representing a combination of a text embedding and an image embedding, wherein the first set of modalities includes text modality, the method further including: extracting text embeddings corresponding to the text modality; and adding the text embeddings to each multi-modal embedding of the plurality of multi-modal embeddings.

In some aspects, the techniques described herein relate to a method, wherein for the one or more matches, the products catalog includes a plurality of multi-modal embeddings, each multi-modal embedding of the plurality of multi-modal embedding representing a combination of a text embedding and an image embedding, wherein the first set of modalities includes image modality, the method further including: extracting image embeddings corresponding to the image modality; and generating a new multi-modal embedding by adding the image embeddings corresponding to the image modality to the text embedding.

In some aspects, the techniques described herein relate to a method, wherein for the one or more matches, the products catalog includes a plurality of separate image embeddings and text embeddings, wherein the first set of modalities includes text modality and image modality, the method further including: extracting image embeddings form the image modality and text embeddings form the text modality, storing the image embeddings form the image modality and the text embeddings from the text modality in association with the one or more matches in the products catalog.

In some aspects, the techniques described herein relate to a method, wherein receiving the indication that one or more of the matches from the products catalog is a confirmed match to the first search query includes receiving an indication of a weak confirmation that one or more of the matches from the products catalog is confirmed match to the first search query, the method further including: updating the one or more matches from the products catalog with at least one of the extracted embeddings and the first query search with a weak confirmation indicator.

In some aspects, the techniques described herein relate to a non-transitory computer readable storage medium storing instructions, which when executed by one or more processors causes the one or more processors to execute a method, including: receiving a first search query associated with searching products, the first search query having a first set of modalities; generating matches based on a cross-modal search using a machine learning model trained to search for matches in a products catalog that match the first search query, wherein matches in the products catalog have a second set of modalities; receiving an indication that one or more of the matches from the products catalog is a confirmed match to the first search query; responsive to receiving the indication, extracting embeddings, based on a neural network, of at least one modality of the first set of modalities of the first search query; updating the one or more matches from the products catalog with at least one of the extracted embeddings and the first search query; receiving a second search query associated with searching products; and generating matches based on a cross-modal search using the machine learning model trained to search for matches in the products catalog that has been updated with the extracted embeddings and the first search query.

In some aspects, the techniques described herein relate to a non-transitory computer readable storage medium, wherein the first set of modalities includes a text modality and an image modality.

In some aspects, the techniques described herein relate to a non-transitory computer readable storage medium, wherein the first set of modalities includes an image modality, and the second set of modalities includes a text modality, and wherein the extracting embeddings includes extracting embeddings of the image modality of the first search query.

In some aspects, the techniques described herein relate to a non-transitory computer readable storage medium, wherein the first set of modalities and the second set of modalities are distinct.

In some aspects, the techniques described herein relate to a non-transitory computer readable storage medium, wherein the first set of modalities includes text modality, the method further including: annotating text of the first search query with structuring information related to the one or more matches in the product catalog prior to updating the one or more matches from the products catalog with the extracted embeddings.

In some aspects, the techniques described herein relate to a non-transitory computer readable storage medium, wherein the first set of modalities includes image modality, the method further including: segmenting, based on a neural network, portions of at least one image included in the first search query that include products, cropping the at least one image to segmented portions of the at least one image prior to extracting embeddings.

In some aspects, the techniques described herein relate to a non-transitory computer readable storage medium, wherein the first set of modalities include image modality, the method further including: determining, using an image matching neural network, a similarity score for the image modality of the search query with respect to each of a plurality of images associated with the one or more matches satisfies a criterion indicating that the image modality is dissimilar; and storing the image modality of the search query in the products catalog in association with the one or more matches.

In some aspects, the techniques described herein relate to a non-transitory computer readable storage medium, wherein the first set of modalities include image modality, the method further including: determining that a quality measure based on at least one of image blur, image noise, or compression artifacts, of the image modality of the search query satisfies a criterion; and storing the image modality of the search query in the products catalog in association with the one or more matches.

In some aspects, the techniques described herein relate to a non-transitory computer readable storage medium, wherein the first set of modalities include image modality, the method further including: identifying a number of regions within an image associated with the image modality; determining a first number of regions within the number of regions that include edges and a second number of regions within the number or regions that do not include edges; storing the image modality of the search query in the products catalog in association with the one or more matches based on a determination that a ratio of the first number of regions to the second number of regions is greater than a threshold value.

In some aspects, the techniques described herein relate to a non-transitory computer readable storage medium, wherein the first set of modalities includes image modality, the method further including: determining, based on image matching or cross-modal matching, a set of data, including texts or images, in the products catalog that most similar to the image modality; determining semantic similarities between members of the set of data; determining at least one statistic including mean or standard deviation of the semantic similarities; storing the image modality of the search query in the products catalog in association with the one or more matches based on a determination that the at least one statistic satisfies a criterion.

In some aspects, the techniques described herein relate to a non-transitory computer readable storage medium, wherein the criterion is a function of a number of images in the products catalog associated with the one or more matches.

In some aspects, the techniques described herein relate to a non-transitory computer readable storage medium, wherein the first set of modalities includes text modality, the method further including: determining a novelty score for the text modality, the novelty score based on comparison of the text modality with text stored in the products catalog in association with the one or more matches; storing the text modality of the search query in the products catalog in association with the one or more matches based on a determination that the novelty score is greater than a threshold value.

In some aspects, the techniques described herein relate to a non-transitory computer readable storage medium, wherein the first set of modalities includes image modality, the method further including: extracting embeddings, based on the neural network, of the image modality; and adding the embeddings of the image modality to pre-existing embeddings of other images associated with the one or more matches.

In some aspects, the techniques described herein relate to a non-transitory computer readable storage medium, wherein the first set of modalities includes a combination of image modality and text modality and wherein for the one or more matches, the products catalog includes a pre-existing single multi-modal embedding, the method further including: extracting text embeddings corresponding to the text modality and extracting image embeddings corresponding to the image modality, adding the text embeddings and the image embeddings to the pre-existing single multi-modal embeddings of associated with the one or more matches.

In some aspects, the techniques described herein relate to a non-transitory computer readable storage medium, wherein for the one or more matches, the products catalog includes a plurality of multi-modal embeddings, each multi-modal embedding of the plurality of multi-modal embedding representing a combination of a text embedding and an image embedding, wherein the first set of modalities includes text modality, the method further including: extracting text embeddings corresponding to the text modality; and adding the text embeddings to each multi-modal embedding of the plurality of multi-modal embeddings.

In some aspects, the techniques described herein relate to a non-transitory computer readable storage medium, wherein for the one or more matches, the products catalog includes a plurality of multi-modal embeddings, each multi-modal embedding of the plurality of multi-modal embedding representing a combination of a text embedding and an image embedding, wherein the first set of modalities includes image modality, the method further including: extracting image embeddings corresponding to the image modality; and generating a new multi-modal embedding by adding the image embeddings corresponding to the image modality to the text embedding.

In some aspects, the techniques described herein relate to a non-transitory computer readable storage medium, wherein for the one or more matches, the products catalog includes a plurality of separate image embeddings and text embeddings, wherein the first set of modalities includes text modality and image modality, the method further including: extracting image embeddings form the image modality and text embeddings form the text modality, storing the image embeddings form the image modality and the text embeddings from the text modality in association with the one or more matches in the products catalog.

In some aspects, the techniques described herein relate to a non-transitory computer readable storage medium, wherein receiving the indication that one or more of the matches from the products catalog is a confirmed match to the first search query includes receiving an indication of a weak confirmation that one or more of the matches from the products catalog is confirmed match to the first search query, the method further including: updating the one or more matches from the products catalog with at least one of the extracted embeddings and the first query search with a weak confirmation indicator.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a block diagram of an example search system.

FIG. 2 shows a block diagram of an example ingestion module.

FIG. 3 shows a block diagram of an example image matching component.

FIG. 4 shows examples of visual-textual embeddings.

FIG. 5 shows an example late fusion operation.

FIG. 6 shows a flow diagram of an example enrichment process.

FIG. 7 shows a flow diagram of an example rule-based selection process for enrichment.

FIGS. 8A-8D describe example embeddings corresponding to catalog enrichment.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

Like reference numbers and designations in the various drawings indicate like elements.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used in the specification and the appended claims, the singular forms “a,” “an” and “the” include plural referents unless the context clearly dictates otherwise. Thus, for example, reference to “a proton beam degrader,” “a degrader foil,” or “a conduit,” includes, but is not limited to, two or more such proton beam degraders, degrader foils, or conduits, and the like.

The various concepts introduced above and discussed in greater detail below may be implemented in any of numerous ways, as the described concepts are not limited to any particular manner of implementation. Examples of specific implementations and applications are provided primarily for illustrative purposes.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

Industrial spare parts search (or products search, in general) can be performed using textual or visual queries combined with static or dynamic filters. Some search systems may allow a user to search for a part in a parts catalog by simply having the user capture an image of the part with their smartphone, or any other device with image capturing capability, and return to the user a list of matching parts from the parts catalog. Such an approach alleviates the need for the user to provide exact part names. Such search systems rely on image matching algorithms to match the image provided by the user with those stored in a parts catalog database. But the accuracy of the search system is reliant on the database including a comprehensive set of images that capture a spare part from multiple viewpoints, including those viewpoints that the user may use to capture the query image. As the viewpoint from which a user may capture an image of the part cannot be predicted, the database would need a large number of images for each spare part. With a spare parts catalog containing hundreds or thousands of parts, the total number of images to support an accurate search can get prohibitively large. In particular, the amount of time and resources that would be needed to capture all the images can be prohibitively large. Thus, actual search systems are often inaccurate in determining matches to user captured images.

Similarly, when a user searches for a part with a text description, very often the user may not know the exact term in the catalog associated with that part, or the part may not be described using the query term due to inaccurate text description. Completing or correcting textual descriptions of all catalog parts or building an exhaustive list of synonyms relevant for each specific dataset is rarely feasible. Here as well, actual implementations of search systems using text searches are often inaccurate.

Thus, traditional text and image matching techniques may not lead to acceptable results with the limited catalog data, or provide acceptable accuracy for instances where the number of parts in the catalog is limited to few parts for which the required data is available.

One approach to addressing the above-mentioned limitations of search systems is to have the system improve its accuracy and search speed over time by leveraging the data entered by the user during search queries. For example, one could enrich the catalog with the search query data provided during successful search sessions. One factor to facilitate such an approach would be to ensure an acceptable initial search performance such that the user is incentivized to provide search query data (i.e., from the very beginning parts could be accurately found albeit with some effort on the part of the user) and a way of capturing the information with respect to the success of each search session.

However, traditional search techniques struggle with providing acceptable performance with the initial catalog data. Moreover, typically users have very little incentive to search with modalities (e.g., text modality corresponding to entering text or image modality corresponding to entering an image for a search query) that are not well represented in the catalog and therefore provide poor results (e.g., users are unlikely to include images in their multi-modal queries if there is little benefit in doing so).

The poor results can be caused by the lack of cross-modal search approaches suitable for effective search results. A typical approach may attempt matching the same modalities from queries and catalog representations, e.g., matching query images only with reference images representing catalog items.

This is by far the most common approach even for multi-modal retrieval, where the same query and catalog modalities are matched and then fused using a late fusion approach.

Moreover, typical part search solutions struggle with capturing the information about the search session outcome. They either completely lack such a mechanism or attempt to capture it implicitly from user interactions such as time spend inspecting items from the result list or some mechanism capturing the user satisfaction with each session.

Consequently, traditional spare part search solutions so not effectively capture novel data during spare parts search sessions that is suitable for a subsequent enrichment of the catalog representation with new modalities.

As discussed herein, methods and systems for search systems are described that address the limitations discussed above. As an example, a novel multi-modal system for spare parts search is described. The system provides satisfactory performance even with sparse catalog data and rapidly improves over time by enriching the catalogs with user query data from successful search sessions.

The search system includes a combination of text search and image matching search capabilities with cross-modal techniques (e.g., Image-To-Text and Text-To-Image) that rely on building a joint visual and textual embedding spaces. Such cross-modal techniques can be successfully applied to the spare parts search problem and provide a strong incentive for users to search with multi-modal queries irrespectively on the modalities representing the catalog. In other words, users have an incentive to include query modalities that were not originally present in the catalog representation. The result of incorporating such a technique is that most of the search sessions benefit from including a query image, even if the catalog is represented only by text. Even if such cross-modal techniques have a lower discriminatory power than an image matching technique, these techniques still provide better ranking of the results when compared to text-only searches.

Moreover, the multi-modal search mechanisms can be augmented with capturing strong evidence regarding the success or failure of each search session. One such mechanism can be based on capturing purchase orders originated from search sessions. In another example, an expert confirmations provided by a human expert can be leveraged towards attributing success to a search session. In some other examples, an external automated search system may provide confirmation of success of a search session.

Such confirmations can be used as an indicator of image or text data provided by the user search query that can be used to enrich the catalog. Specifically, user search query data from such confirmed successful search sessions can be selected for enriching the representation of the confirmed part in the catalog. The selection process can be based on analyzing the quality of the query data and its novelty when compared to the catalog data representing the confirmed part at the time of the search.

This mechanism can be used to enrich the catalog with additional images depicting the part or with additional textual data such as attribute descriptions or synonyms.

The new data added to the catalog can be used in subsequent searches. For example, apart that was initially represented only by its name and a few textual attributes, could be successfully retrieved by using a query image and filtering (using, for example, cross-modal image-to-text component). If such result is then confirmed, then the query image could be selected to represent the confirmed part in the catalog. As a result, the enriched part would potentially be easier to find in subsequent searches because post-enrichment it is likely that future query images will not only be matched due to the image-to-text capability but also due to the image-to-‘All Catalog Modalities’ capability providing better evidence for correct matching.

In some examples, the search system can be integrated with a customer service platform, where experts provide a confirmation of the identified parts (or provide alternative solutions). Confirmation requests can include user query data, ranked results and the part selected by the user (in this case often a technician). This information not only allows to simply inspect and confirm the part selected by the user, but also provides an additional context and a list of alternative results. In this manner, the proposed combination of components (including the cross-modal capability) can further reduce the confirmation effort and speed up confirmation responses. In some examples, experts can have access to the search capabilities of the search system and can modify the query data to perform their own search for the target part.

Further, the data captured and selected for enrichment by the proposed solution is well suited to be included in datasets used for training of search components, which can include, for example, text search components and image search components. The value of this data for training can be attributed to the fact that the data represents real world queries. Combining such data with catalog data allows to train search components that can compare queries and catalog data in a more meaningful way. It should be noted that many modem deep learning approaches can be trained with unlabeled or only weekly labelled data. Thus, the search system may utilize even data that is not confirmed for training.

One of the challenges that search systems encounter is the lack of rich data with adequate quality. In particular, for spare part search systems, the amount of information characterizing each item in the catalog can be small and vary between spare parts subdomains, catalogs, and even similar parts.

In some instances, the textual data is heavily abbreviated. Further, some textual data is unstructured, i.e., attributes of each spare part are described in free form text. In addition, data can be often incomplete. For example, some images of attributes may be missing for some spare parts (e.g., only some “mufflers” may include “alloy type” information). In some instances, data may be inconsistent. For example, some parts in the catalog may be described using a vocabulary or formatting that is substantially different from the terminology used for other parts in the same catalog, even though these parts may be similar or even equivalent. In some examples, some catalog data may be inaccurate or duplicated. It may not be uncommon to encounter datasets where there are no catalog images, or where all parts from the same category of parts are represented by a single image showing one specific part from that category. Some catalogs can include parts represented by images with poor quality or showing packaged parts. These challenges can be barriers to enabling effective and robust visual search.

Large variance in the expertise of the user using the search system can also pose a challenge. Some technicians may identify parts based on exact text strings (e.g., using model number printed on a part). Often such users use the search system to retrieve additional information about a part or confirm the adequacy of the part for their specific application. At the same time, some unexperienced users may even not know a coarse textual term that would allow them to initiate a text search for a given part. Other users may not know part specific terms, but they may know how to describe their function or would simply prefer capturing a picture of a part that they have in their hands.

Often users search using different textual terms than those used to describe parts in the catalog data (e.g., a user may search with a term ‘muffler,’ but the target part is described in the catalog as ‘pneumatic silencer’). In such instances, the search system may not find the part in the catalog, leading the suer to incorrectly conclude that the catalog does not contain the needed spare part. This may also lead users to lose confidence in the effectiveness of the search system. Incorrect results may also occur due to typos, text formatting variations, e.g., words are split/merged in diverse ways, quantities describing parts properties may be formatted differently (punctuation, spaces, dimension order, different units etc.).

Often catalogs contain hundreds or even thousands of very similar parts. Therefore, any effective search system needs to either provide convenient ways of refining the initial queries until the target parts can be identified or provide convenient search methods with strong discriminatory power capable of meaningful ranking based on the smallest available evidence (e.g., highly discriminatory image matching).

Some users, even when selecting a catalog part that appears to meet their needs, may seek a final confirmation of their selection by a domain expert. The need for expert confirmation may arise from missing data that prevents the user from continuing with their selection, user's lack of expertise, or may arise from some processes internal to the customers (e.g., procurement processes). The time spent by domain experts on confirming or correcting the identified parts can be very costly. Moreover, many search interactions, e.g., dialogues between users and experts take place within tools that are not suitable for capturing and reserving the knowledge from the exchanged data (e.g., telephone, or even chat tools), wasting the opportunity for collecting data that could improve the search system. Some of the above problems are also present in other domains (e.g., vocabulary gap is present in any product search). But it is the combination of very demanding search requirements and poor data quality that makes the spare part search particularly challenging.

Solutions based on single modalities such as full text search or visual search alone may not meet these challenging requirements without leveraging specific assumptions and resolving to custom implementations. Adaptation of such solutions to other customers is often too costly. Also, since each solution is custom, the data collected in each case varies. This fragmentation of collected data may hinder reaching desired data volumes for training state of the art machine learning methods.

The example search systems discussed herein address the abovementioned challenges. The example search systems provide several advantageous capabilities. For example, users can use any search modality to search a part regardless of the modalities used to represent the part in the spare parts catalog. This in turn allows good performance even when the initial version of the catalog data is sparse and of poor quality. Users have a clear incentive to use as many search modalities as possible. This opens a unique possibility to effectively harvest user query data that contain modalities that are not present in the catalog. The catalog can be effectively enriched with new modalities, which can aid in improving the search performance of the search system over time. For example, enriching the catalog data with user captured images can improve visual search in catalogs that initially lacked image representations of parts. These capabilities can lead to better search results at all stages of the system evolution and translate into reduction of the search time for the users, and effort from external confirming entities such as, for example, expert systems. While the example search system are discussed primarily in relation to spare parts or industrial parts, it should be noted that the search system is not limited to only spare parts or industrial parts, and that the methodologies discussed herein can be applied equally to other parts or products in general.

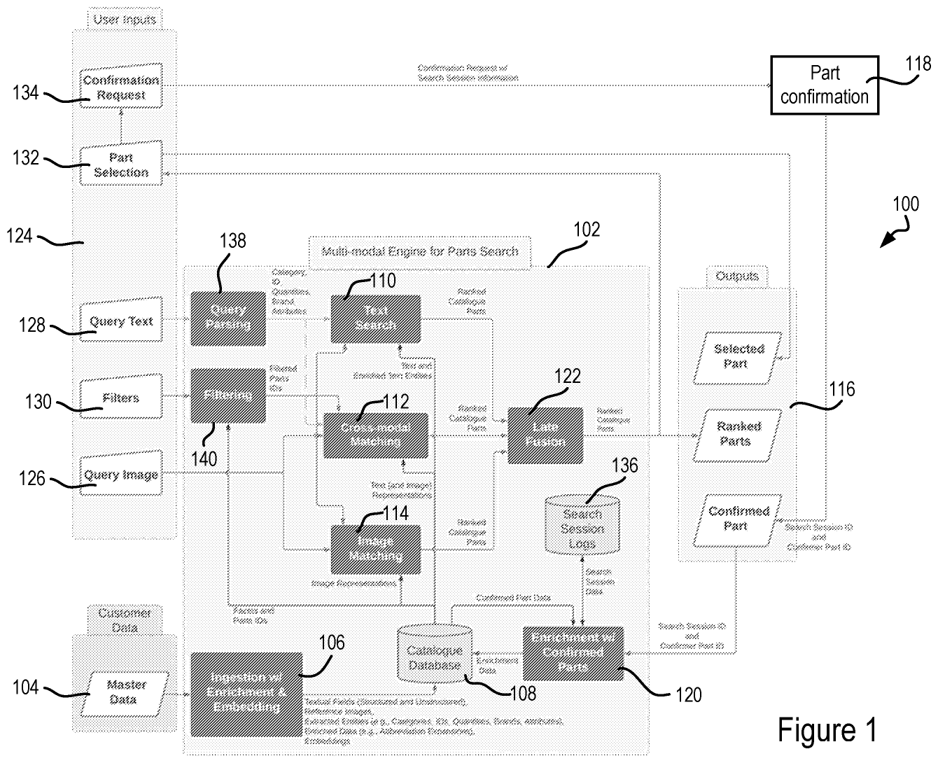

FIG. 1 shows a block diagram of an example search system 100. The search system 100 includes a multi-modal parts search engine 102 that can receive query data and catalog data and provide a user with search results. The multi-modal parts search engine 102 can include an ingestion module 106, which can receive parts catalog data from a master data source 104. The ingestion module 106 can imports the data from the master data source 104, enriches it and extracts features needed to represent the data in a way that is convenient for efficient and effective search. The ingestion module 106 can extract features of images or text associated with parts. In some instances, the features may already be present in the data received from the master data source 104. In some implementations, the ingestion module 106 can utilize neural networks (such as text encoders or image encoders) to extract features of the texts and images associated with parts. The ingested data and extracted features can stored in a catalog database 108. The multi-modal parts search engine 102 can also include one or more search components such as, for example, a text search component 110, a cross-modal matching component 112, and an image matching component 114. These search components can be loaded with the catalog data and features relevant to their search capability. Users can quickly identify catalog parts that meet their needs by formulating unimodal or multimodal queries consisting of Query Text, Query Image (or Images) or Filter Selections. In response to the queries the multi-modal parts search engine 102 can produce an output 116 containing lists of catalog items ranked according to their relevance to the user queries. At this point users can inspect the ranked results, refine their queries, and when they believe that they identified the correct parts they may select them for performing use-case specific actions such as for example initiate purchase orders or request a part confirmation 118. Purchase orders or part confirmations can be used as strong indication for search session success and trigger catalog enrichment with selected elements of the user queries using the enrichment module 120.

Once the enrichment has occurred, the new data elements can be used and matched in subsequent search queries. In cases where the new modalities did not exist at all in the catalog, one may want to activate them for search after enough modality coverage is achieved.

The search components can be capable of matching different pairs of query-catalog modalities. For example, the text search component 110 can performs full text search (i.e., Text-To-Text Matching). The image matching component 114 focuses on the Image-To-Image comparisons. The cross-modal matching component 112 can perform cross modal Image-To-Text matching and in some implementations can be extended to ‘Multi-modal Query’-To-‘Multi-modal Catalog’ matching. Each of these components output ranked list of results that can be fused by a late fusion module 122. It should be noted that the three abovementioned components could be unified into two or even one search component. Regardless of the manner in which the search components are implemented, the multi-modal parts search engine 102 should retain the strong cross-modal capabilities (Image-To-Text and Text-To-Image matching between query and catalog) thanks to the joint visual and textual embeddings.

For simplicity, FIG. 1 depicts a deployment with a single customer with one catalog. However, the proposed solution is suitable for a multi-tenancy scenario where the same service is used simultaneously by technicians from multiple customers, each with one or more catalogs of parts. The part confirmation module 118 can be hosted within an external system, such as that belonging to the customer (e.g., Customer Support Service).

The master data source 104 can include data representing catalog of spare parts or home improvement components that should be made searchable by the multi-modal parts search engine 102. In other words, the data can be viewed as a combination of all data types characterizing customer's catalogs. On a high-level the master data source 104 may contain machine hierarchies, parts representations, and documents. Typically, every catalog part is represented in the master data source 104 by a subset of data fields such as, for example, (1) an industrial unique Identifier (ID), a model number, and in some cases a serial number, represented as an alphanumerical string; (2) unstructured textual information (e.g., product name, and/or a brief description); (3) structured textual information that may follow some flat or hierarchical ontology (e.g., category, sub-category, brand or/and manufacturer, specific attributes, etc.); (4) images depicting the part including one or more thumbnail images (a smaller version of a full digital image that could easily be viewed while browsing the catalog), one or more high-quality images depicting the part in some characteristic viewpoints, e.g., on a simple uniform background that is usually white (such images are typical for representing catalogs within online shopping services); (5) a set of high-quality images captured specifically for the purpose of image matching (these images are often captured using special scanning devices and depict the part from a relatively large, predefined number of views (e.g., 30)); and (6) documentation associated with the part.

Very often a significant part of the catalog data can be received in the form of Bills of Materials (BOM) for a set of machines. A BOM or machine structure can include a list of the raw materials, sub-assemblies, intermediate assemblies, sub-components, parts, and the quantities of each needed to manufacture a machine. The BOM can define products as they are designed (engineering bill of materials), as they are ordered (sales bill of materials), as they are built (manufacturing bill of materials), or as they are maintained (service bill of materials).

User inputs 124 can be data that is provided by a user. The user inputs 124 can include search query images 126, search query text 128, and filters 130. The search query images 126 can correspond to an image modality and can include one or more images (including video) captured by the user depicting a part or parts. In some instances, the search query images 126 can include the part that has been unmounted from a machine (e.g., placed on a table or a floor or held in a hand). However, in some instances the search query images 126 can depict the part that is still installed within the machine and only partially visible. It should be noted that the described approach to search could be easily extended to queries consisting of multiple images or even videos. In such cases the catalog enrichment described herein could be applied equally to multiple images and videos. In the case of videos, the multi-modal parts search engine 102 can implement well-known techniques for extracting key-frames from the videos.

Search query text 128 can correspond to a text modality and can include text strings describing the part to be searched. In some examples, the search query text 128 can include one or more of the following data. (1) Part Identifier or a model number e.g., “01551-0509”, “00221-0199”, “C02W22RDHTD6”, (2) part category e.g., “o-ring”, “pneumatic silencer”, “lawn mower”, or description of its function, e.g., “black metal disk with holes”, or category abbreviations e.g., “cyl” (cylinder), “mtg” (mounting), “shc” (socket head cap), (3) brand or/and manufacturer e.g., “Siemens”, “Bosch”, (4) quantities representing attributes e.g., “32 mm”, “12V”, “230A220V”, “27-watt”, “9”, (5) other attributes e.g., “grey”, “steel”, “silicone” or attribute abbreviations (e.g., “PTFE” and (6) reference to standards, e.g., “ISO-4762”, “DIN 41612”.

Filters 130 can aid in reducing the search space by selecting a node from a hierarchy of parts or a bill of materials for a specific machine or selecting an attribute or a facet of a part. For simplicity it is assumed that filters 130 are applied only to well-structured and complete catalog data. In cases where the number of possible filters is large it is advantageous in some implementations to permit searching among filtering options using names of the filters.

To allow fast search iterations and refinement a ranked list of catalog parts can be updated every time the user adds or modifies one of the query modalities (e.g., within less than 1 second). Every time the multi-modal parts search engine 102 produces a new ranked list of results the users can inspect it, access more detailed information for specific parts (including consulting their documentation), refine further his query, and finally, when the user believes the correct part has been identified, the user may perform Part Selection 132 where the part is chosen for application specific actions such as for example initiation of a purchase order or requesting part confirmations. Alternatively, the user can abandon the search session without finding any part that matches the user's needs. In some implementations, the user may request expert assistance without selecting a catalog part (i.e., the request will contain only the multi-modal query and ranked catalog parts). Search sessions concluding with purchase orders or expert confirmations can then trigger catalog enrichment with selected elements of the user search query.

In some instances, a part selected for ordering or delivery from a warehouse can be validated (confirmed) by an expert in the field. Very often such experts are employed by the customer as Customer Service Agents (CSA) or Warehouse Managers. In such cases, users can have an option to submit a confirmation request 134 for the selected part. Often, access to such experts can be limited and costly. In traditional search systems, experts may provide their services via outdated or inadequate tools. Moreover, since many such systems prevent efficient digestion of the exchanged information, the knowledge created in the processes cannot be easily leveraged to improve automatization. Even advanced Customer Service (CS) ticketing systems lack functionalities that would speed up spare part searches and capture the exchanged information in a way that facilitates automatization.

In the multi-modal parts search engine 102, confirmation request 134 can also include multi-modal queries performed by users together with ranked results produced by the multi-modal parts search engine 102. In such instances, the effort needed by the experts to confirm the part is significantly lower than the effort of supporting similar requests without such information.

The experts can use an external system (not shown) such as an Enterprise Resource Planning (ERP) tool, Customer Support (CS) ticketing or even e-mail. Every confirmation request 134 sent from the multi-modal parts search engine 102 can then create a ticket in such system with information about the entire search session (query, ranked catalog parts, the selected part). These tickets can include means to access a Graphical User Interface (GUI) for the expert to visualize the search session performed by the user that led to the confirmation request 134. For instance, the means could be a link to a web application running on an Internet browser. The GUI could then offer an option for the expert to confirm the part ID and automatically communicate back the confirmed part ID to the multi-modal parts search engine 102 and to the ticketing system. Alternatively, the GUI could offer the user the possibility to generate an information blob that the expert could then import into the corresponding ticketing system, ERP, or email.

In some instances, the multi-modal parts search engine 102 can allow the experts to perform their own searches (independently from the user's search session). In other words, in cases the part selected by the user was wrong the experts could perform their own search session with her own search terms and filters to find and indicate the correct part. Optionally, such sessions could use user's sessions as starting points. In some examples, the part confirmation module 118 can be a submodule of the multi-modal parts search engine 102, providing Web UI and ticketing functionalities.

Expert confirmations can provide a strong indication of successful search sessions, and therefore especially useful for the enrichment mechanism described herein. In some implementations and deployments, similarly strong indication can be obtained by capturing purchase orders submitted by the technicians at the end of a search session. Other indication that a catalog item is somehow relevant to a search query are user interactions indicating user's interest, e.g., explicitly marking a search session as successful after selecting a catalog item in the GUI, or even spending considerable time reviewing information of a particular catalog item returned by the system.

In some implementations the part confirmations module 118 could be implemented by an automatic artificial intelligence (AI) subsystem. For example, the part confirmation module 118 can be based on the cross-modal matching approach, but optimized for providing more reliable responses than the component used during interactive search while sacrificing response time. Other possibilities for developing such automatic confirmation system include designing a template for human expert-user interactions. Such a template would include possible expert questions to the user that, when replied within a set of possible answers, leads to the correct part from the catalog. By training an automatic component specialized in automatic machine expert questions based on training data captured during such interactions, the system could lead to an automated confirmation depending on the responses from the user. A variant of that approach consists of inferring the right expert questions from previous logged interactions, without the need for a template. An intermediate variant can include starting with a template and evolving the set of expert questions based on human expert follow-up questions.

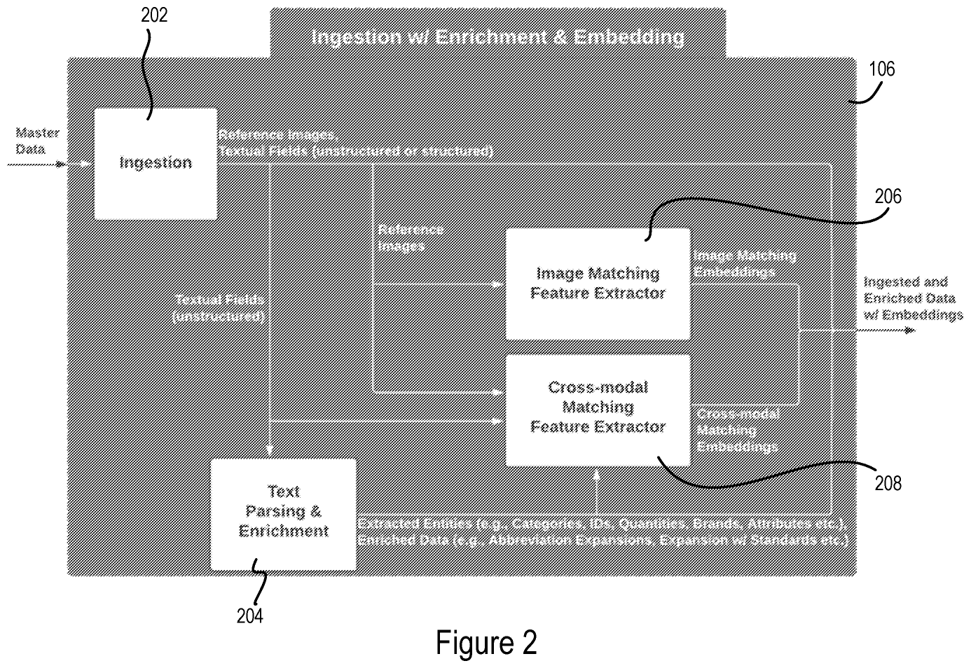

FIG. 2 shows a block diagram of an example ingestion module 106. The ingestion module 106 includes an ingestion block 202, a text parsing and enrichment block 204, an image matching feature extractor 206, and a cross-modal matching feature extractor 208. To make a catalog searchable first the master data source 104 needs to be ingested. Also, it is a common requirement for parts search to enrich the ingested data to a level required by the search components. Moreover, some search components from the described system need catalog parts to be represented by feature vectors (embeddings). These steps can be executed in part by the ingestion module 106 (also referred to as “ingestion w/ enrichment & embedding module”). As a result of the processing carried out in the ingestion module 106, the ingested data, the enriched data, and the extracted features are sent and stored in the catalog database 108 and are later distributed to the relevant search components. In some implementations, the ingestion, enrichment and embedding of the data can be available through an application programming interface (API) permitting both: batch processing and updating of individual parts.

Data ingestion is the process of transporting data from one or more sources into the multi-modal parts search engine 102. In most cases, the first step of ingestion involves adaptation of the source API or format to the one required by the multi-modal parts search engine 102. In most instances, this is combined with mapping of the relevant data fields from master data source 104 to standard data fields defined by the multi-modal parts search engine 102. Very often such mapping is further combined with some transformation of the master data source 104 or an enrichment process described herein. The output of this step, namely structured and unstructured text fields and reference images, can be stored in the catalog database 108, and passed to the text parsing and enrichment block 204 and the various feature extractor blocks.

The parsing and enrichment block 204 enriches the unstructured text representing the catalog. Such richer and higher-quality textual data improves the results produced by the text search component 110 and the cross-modal matching component 112. The enrichment processes are aimed for instance at identifying useful text fields, such as the category or a quantity, or at creating new data, such as abbreviations meanings. With this data, the system can emphasize the text search more on relevant information and yield better results. In some variants of the system, the component may be used also to parse and enrich the search query text 128 (i.e., implementing the Query Parsing component shown in FIG. 1).

The enrichment of the catalog data is a process that creates a new version of the ingested metadata that has additional information. This information is either extracted directly from the catalog, such as detection of keywords that best describe a given product or by adding information such as expanded values of abbreviations. The parsing and enrichment block 204 can extract free text structure from part name or short descriptions by identifying entities such as part ID, category or function, manufacturer or brand name. One possible implementation of the ID detection can use regular expressions (regex or regexp). Manufacturer or brands names may be detected by matching elements of the input with a curated list of manufacturers and brands. Part category detection can be implemented using Part of Speech (POS) detection and rules e.g., for every two consecutive text tokens tagged as a noun take the second of the two tokens as a category. The parsing and enrichment block 204 can also detect quantities and generate formatting alternatives. Basic quantity detection can be based on unit detection using regular expressions and alternatives generation can be carried out using a predefined list of variations for a given unit. The parsing and enrichment block 204 also can detect and expand abbreviations which can be implemented using a simple curated look-up table, e.g., “mtg”→“mounting”, “cyl”→“cylinder”, “noz”→“nozzle”. The parsing and enrichment block 204 may also detect standards (e.g., ISO, DIN) and enrich the catalog representation based on the assigned standard specification. For example, detection of standards can be implemented using regular expressions and the enrichment with standards can be implemented using a look-up table.

As some of the search components rank products based on comparing query and catalog embeddings, the catalog ingestion process can extract the required embeddings for every imported part. The extracted embeddings can be stored in the catalog database 108 and distributed to the correct search component.

The complexity of the feature extraction varies depending on the search component that is using the data. In the case of the implementation shown in FIG. 1, embeddings can be extracted for the cross-modal matching component 112 and image matching component 114. It should be noted that many implementations of the text search component 110 may not require extraction of embeddings and can directly index and use the ingested text elements and their enrichment.

The image matching component 114 can use global image features (embeddings) extracted using deep learning neural networks (i.e., the output of the last Neural Network layer is taken as the global image features). The image matching component 114 can be implemented by representing every reference image with its own feature vector (embedding). Therefore, the image matching feature extractor 206 extracts embeddings for every ingested reference. The image matching feature extractor 206 can use the same deep learning model as the one used in the image matching component 114 in order to ensure comparability of query and catalog embeddings.

The cross-modal matching component 112 can process embeddings for every modality used to represent each ingested part (namely text or/and reference images). Embeddings of the textual representation can be obtained by a Text Encoder, while embeddings of reference images can be obtained by a Visual Encoder. The final embeddings depend on the approach taken to represent multiple data elements belonging to each modality. In one scenario, image and text embeddings are added to create a single multi-modal embedding. More detailed description of the two encoders and possible strategies for representing multi-modal catalog data are provided further below. It should be noted that the text embeddings can be extracted solely from the unmodified ingested text fields selected for search (structured and unstructured), or in some implementations, they can also include the enriched unstructured version of the text representation. Moreover, the enrichment permits excluding from the embedding process text elements that have no semantic meaning, and therefore are not well suited for representations. In some instances, well known algorithms such as for example CLIP and ALIGN can be utilized for embeddings extraction.

Referring again to FIG. 1, in some instances, the multi-modal parts search engine 102 can include a catalog update module to update the catalog database. Such updates may include adding, removing, or modifying individual catalog parts. In other words, every time a part or a set of parts are added of modified, the multi-modal parts search engine 102 can ingest the data, parse and enrich, extract embeddings, store the produced data in the catalog database 108, and send the relevant elements of the data to the individual search components. Moreover, such updates include updates of part representations triggered by the enrichment with data elements from a successful query described in more details below. It should be noted that, if needed, computational cost of partial updates can be reduced by optimization of the described process that would avoid re-generation of data not affected by a particular update.

In the example shown in FIG. 1 all catalog data is stored in the catalog database 108. This includes the ingested data, textual data generated by the Enrichment module and all the extracted features (i.e., textual, image and multi-modal embeddings). The catalog database 108 is the source of data for all search components. In other words, each search components receives from the catalog database 108 the data that is needed to perform the specific search type. In some examples, the catalog database 108 can store original catalog data imported by the ingestion module 106. This data can include structured and unstructured textual data. This data can be organized in data fields storing a predetermined type of data such as unique internal identifier, ‘part identifier’ (external), ‘part name,’ ‘short description,’ and other structured data. Moreover, the catalog database 108 can store information on which data fields should be searchable by Query text and which ones should be also available as filters. The catalog database 108 can also include reference images depicting catalog parts. Some implementations may also include information about the type of the image or/and which search components should use the image (e.g., cross-modal matching component 112, image matching component 114, or both).

The catalog database 108 can also store enriched version of the data produced by the enrichment module 120. The enrichment information could be stored in data fields storing specific type of data, e.g., part name with abbreviation expansions, automatically detected brand or manufacturer, textual enrichment from standards etc. The catalog database 108 also can store feature vectors or embeddings representing catalog parts that can be provided to the search components such as, e.g., the cross-modal matching component 112 or the image matching component 114. These components can access updated feature vectors representing the catalog parts upon their initialization or whenever a catalog part data is updated. It should be noted, that in some implementations these search components could store their embeddings in a persistent way eliminating the need to store them in the catalog database 108. In such cases, every time a catalog part data is added or modified in the catalog database 108, a feature extraction process can extract the updated embeddings and load them into the relevant search component (i.e., without storing the embeddings in the catalog database 108).

Referring again to FIG. 1, the multi-modal parts search engine 102 also can include session logs database 136. In some implementations the original user inputs can be stored as part of search session logs that include search session identifiers, query textual data and filters, references to the captured and stored query images, and results produced by every component in response to every iteration of the query and stored in the session logs database 136.

The image matching component 114 matches search query image modalities with stored reference images to determine matches. The image matching process also called Instance Search or Instance-level Image Retrieval (IIR) in the field of Content based Information Retrieval (CBIR), allows users to rapidly find spare parts by capturing pictures of the parts to be found. The image matching component 114 matches visual appearance of parts appearing in query images with appearances of parts depicted in reference images representing catalog parts. Therefore, the image matching component 114 can be viewed as an example of unimodal Image-To-Image instance search.

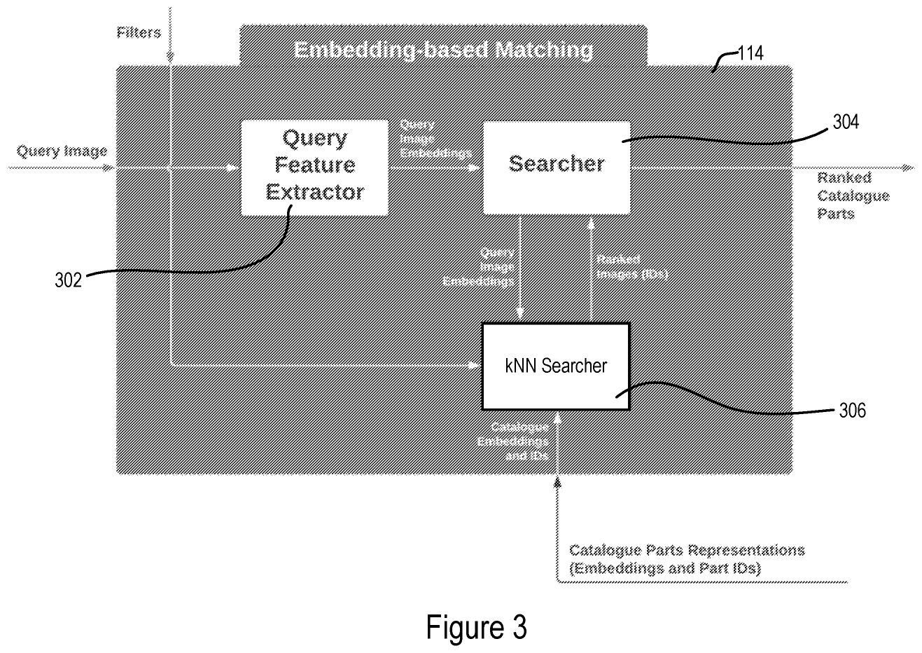

FIG. 3 shows a block diagram of an example image matching component 114. The image matching component 114 includes a query feature extractor 302, a k-Nearest Neighbor (or a kNN searcher 306), and a searcher block 304. For many searches the image modality search can be the fastest, most convenient, and most accurate way of finding parts, especially when their appearances are specific and unique. In such cases, image matching may often lead to finding the correct part with just an initial query image and no other modalities nor refinement. In cases where the users do not know the name of the searched part, or their vocabulary may be different from the words used in the catalog, the image modality provides a particularly useful way to initiate search sessions that can then continue by introducing additional modalities.

However, image matching can rank only those catalog parts that are represented by reference images depicting the parts from a similar viewpoint as the one in the search query image. Since a query image can represent an arbitrary view of the part a typical approach is to represent every catalog part from all its viewpoints (or at least from the most common ones). Such requirement represents an important barrier to the usage of image matching in practical scenarios. For example, image matching for catalogs with tens of thousands of parts can be implemented by using 30 or more viewpoints captured in a controlled photographic setting (uniform background, uniform lighting conditions, etc.) for every catalog part.

The systems and methods discussed herein provide a solution to the abovementioned problem by enabling querying with images (and other modalities) in catalogs with no or very few reference images with acceptable performance and then progressive enrichment of the catalog with query images from successful search sessions and consecutive improvement of the search performance. In some example implementations, once enough catalog parts are represented by images, a dedicated, more precise image matching component, like the one described in this section, can be activated and included into the multi-modal retrieval.

Image matching suitable for parts search needs to be robust to lighting conditions, complex backgrounds, scale changes, and to some extend viewpoint changes. Moreover, the image matching component 114 should not require costly re-trainings with every new dataset loaded into the system.

Such requirements can be met using Deep Neural Networks to extract global features (image embeddings) (as discussed in [DUBE20], [CHEN21] for generic retrieval tasks). Similarity between images can then be computed in an efficient and effective way by calculating distances between such features. Such similarities can be then used to rank the catalog parts.

Referring to FIG. 3, a query feature extractor 302 computes image embeddings that represent image content. This way, the query feature extractor 302 can reduce the dimensionality of the input images by transforming them into vectors of fixed dimensions. It is well known that such embeddings can be obtained by Deep Neural Networks such as Convolutional Neural Networks or Transformer Neural Networks. For example, one can use a EfficientNet [MING19] or a Swin Transformer [LIU21] model pre-trained on a classification task, fine tune it with parts datasets and use their backbones for the feature extraction task. It should be noted that the Deep Learning model used for extracting Query Image embeddings can be the same as the one used in the ingestion module 106.

Once the images are embedded into vector representations, the searcher block 304 compares the query image embeddings with the embeddings representing the catalog images. This comparison can be performed by using a similarity metric such the very well-known cosine similarity that measures the similarity using the cosine of the angle between two vectors in the multidimensional embedding space. The computed similarities can be then used to rank the catalog parts.

It is often convenient to implement the search as two modules: (i) k-Nearest Neighbor (kNN) Searcher (kNN searcher 306), and (ii) a Searcher module (searcher block 304) implementing any logic specific to the matching module. The purpose of the kNN searcher 306 is scalable and fast search returning k catalog image embeddings that are most similar to the query embedding. KNN for small catalogs can be performed using brute force approach exhaustively evaluating all possible matches. Large catalogs may utilize Approximate Nearest Neighbour strategies such as Hierarchical Navigable Small World (HNSW) graphs [MALK18]. Since kNN is an important and common operation in a multitude of applications, one can implement it by using specialized databases or libraries supporting Vector Similarity Search [hnswlib]. The kNN module is also a convenient place to reduce the search space based on provided filters.

Since in the case of image matching each part can be represented by several viewpoints, the searcher block 304 can convert the similarities computed between the query and the reference images into ranking of the catalog parts. One effective method is to simply take the highest found similarity between the query and reference images representing a given catalog part. These similarities can be used to produce the ranking of the catalog parts.

It should be noted that for the query and catalog embeddings to be comparable, the same method and Deep Neural Network model can be used in the ingestion module 106 that extracts the embeddings for the catalog images.

The purpose of the text search component 110 is to rank catalog parts based on matching query and catalog words. As an example, two different use-case scenarios involving text search can be contemplated. In the first scenario the user (usually a technician) knows very well the terminology used to name the parts in the catalog. More specifically, in this scenario the user has knowledge or access to technical terms, attributes or even various identifiers characterizing the catalog parts. In the second scenario the user does not know the exact words or terms used to characterize the part the user needs. Often the user may not know how to initiate a textual query, or at most the user can describe the part with synonyms or by describing its visual appearance. The Text Search component aims at addressing the first scenario where the user knows the appropriate textual terms that can help with the search. The second scenario can be addressed by incorporating a Cross-modal Matching (in fact Multi-modal) component using [CLIP] or [ALIGN].

The Text Search component described in this section aims at addressing search based on exact matching (often referred to as Full Text Search), but may include a certain level of matching fuzziness, a sub-string matching, and a certain robustness to formatting variations (word splitting/merging, variations in quantity formatting etc.). Matching certain textual fields can be given special weights.

Referring again to FIG. 1, the query parsing module 138 can extract the structure of and enrich the text search query. Parsing can identify useful query fields, such as the category or a quantity, or at creating new data, such as abbreviations meanings. With such data the text search component 110 can emphasize the search more on relevant information and yield better results.

One possible implementation of the query parsing module 138 is to use the parsing and enrichment block 204 used in the catalog ingestion module 106 (see FIG. 2). The query parsing module 138 detects entities in the query such as IDs, category, manufacturer, or brand, detects quantities and expands them with common formatting variations, and detects abbreviations and expands them with their meaning. This expanded query terms and additional structuring can be leveraged by the text search component 110 for increasing the robustness of the search to formatting variations and weighting specific matches based on their entity types.

The output of the query parsing module 138 can be also send and leveraged by the cross-modal matching component 112 as indicate in FIG. 1 (a dashed connector). In this case parsing permits controlling which query elements are passed to the cross-modal matching component 112. This is a useful possibility since some joint Visual-Textual embedding approaches, e.g., [CLIP] or [ALIGN], are not well suited to representing IDs or quantities.

The Text Search can be implemented as Full Text Search approach which is a comprehensive search method that compares every word of the search request against every word within the document or database. In our case, the Text Search ranking calculates relevance scores for each pair of catalog textual representation and Query Text pair. Such ranking can be implemented with a commonly known bag-of-words retrieval functions such Term Frequency-Inverse Document Frequency (TF-IDF), its improvements such as Okapi BM25 or its more modem modification like BM25F. Fast search responses can be achieved using the well-known inverted file structures. Fuzzy string matching can be implemented by the well-known Levenshtein edit distance, and fast substring matching can be implemented with N-gram index. Robustness to formatting variations can be achieved by query expansion using the quantity variations generated by the Query Parsing.

Cross-modal (or multi-modal) matching can be implemented using the cross-modal matching component 112. In its most basic form this component takes as input a Query Image and compares its content with textual descriptions representing catalog parts, producing as output a list of catalog parts ranked according to their relevance to the Query Image. Therefore, the component is critical for providing strong reasons for searching with query images in textual only catalogs, and consequently, critical for enrichment of catalogs with query images. It should be noted that the cross-modal matching component 112 permits straightforward extension of the functionality of this component to include additional input in the form of Query Text (or selected elements of Query Texts obtained from Query Text Parsing) and permits comparing such queries to catalog representations consisting of text and images. Implementing and activating such options needs to be considered in the architecture of the overall system and is discussed in more detail below.

The cross-modal matching component 112 can facilitate in learning joint visual-textual embeddings space. One could consider several strategies for implementing Image-To-Text matching. But building image classifiers and using their textual output for text search results in poor performance due to the reliance on predefined taxonomies of parts, and has prohibitive offline annotation requirements.

One feasible strategy for implementing this module is to use joint Visual-Textual embedding space as feature extractors for both, images and text, and perform direct ranking of the catalog parts by searching for the nearest neighbors in the joint embedding space.

More specifically, the cross-modal matching component 112 can employ an architecture and training approach of CLIP (Contrastive Language-Image Pre-Training) [CLIP], ALIGN (A Large-scale ImaGe and Noisy-Text Embedding) [ALIGN] or similar techniques. These methods not only can be trained with data that is much easier to obtain but has been shown to generalize better than any of the earlier approaches.

While the remainder of this section focuses on the implementation of the cross-modal matching component 112 using the CLIP approach, it should be noted that the ALIGN [ALIGN]method is conceptually very similar to and shares with CLIP all the advantages that can be utilized for the implementation of cross-modal matching component 112. Therefore, it should be feasible to implement the proposed invention with ALIGN or another similar method.

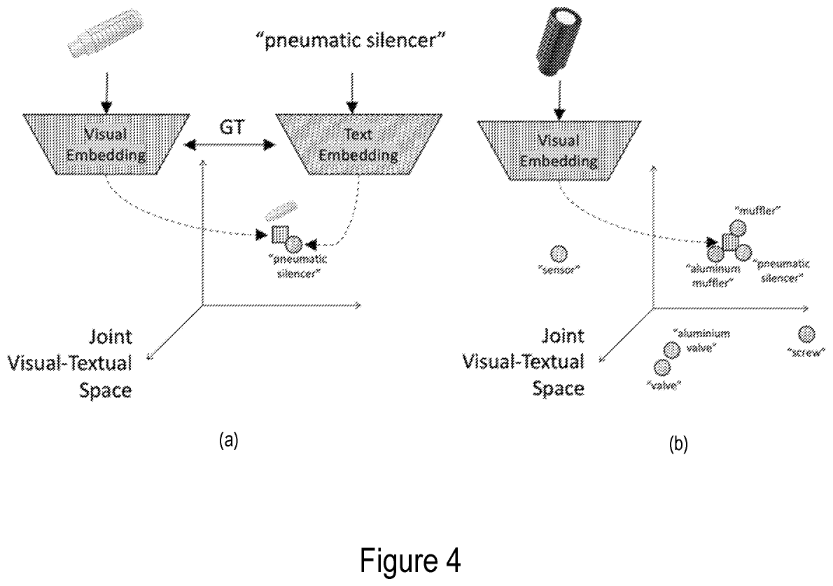

FIG. 4 shows examples of visual-textual embeddings. In particular, FIG. 4 shows examples of a joint Visual-Textual embedding using a method like CLIP. The model consists of two sub-models: Visual Embedding (often referred to as an image encoder) and Text Embedding (often referred to as a text encoder). Both sub-models embed their respective inputs (images or text) into a joint Visual-Textual vector space aiming at representing semantic concepts present in these inputs. The most important aspect of CLIP is that it encodes images and text into the same vector space where images and text representing related concepts are close in the space.

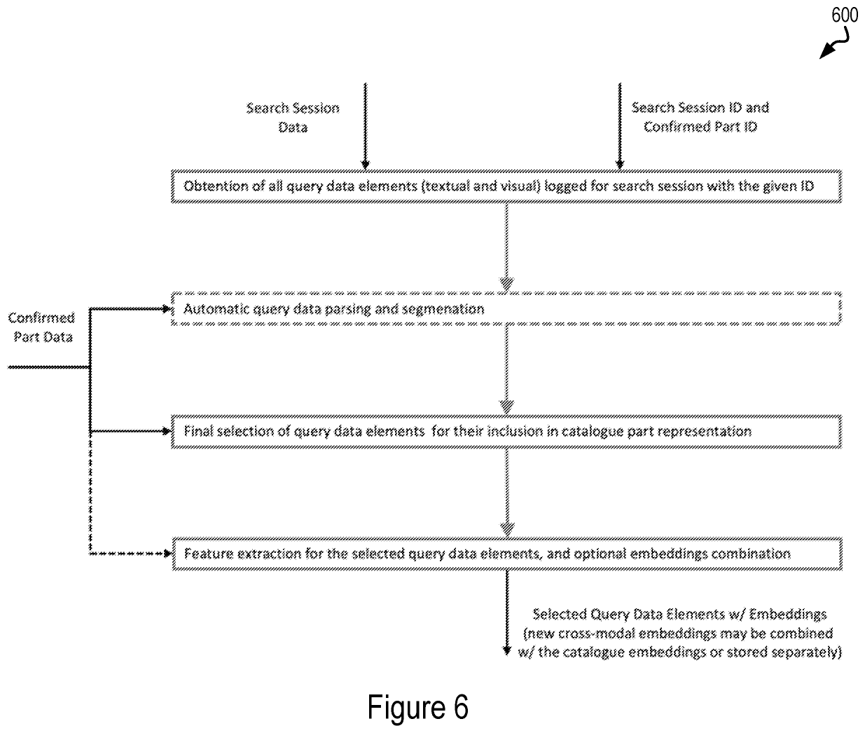

During training, shown in FIG. 6(a), both encoders are optimized to maximize similarity between images-text pairs representing the same concepts and minimize similarity between unrelated pairs. More specifically, the embedding space is learned by jointly training both encoders (the text encoder and the image encoder) to maximize the cosine similarity of image and text embeddings of the N real image-text pairs in the batch while minimizing the cosine similarity of the embeddings of the N2−N incorrect pairings [CLIP]. FIG. 6(a) illustrates the desired training outcome for a single pair where an image of a pneumatic silencer is paired with text ‘pneumatic silencer’. Ideally, both feature vectors, the one extracted from the image (shown as a square) and the one extracted from the text (shown as a circle) should lie close together in the joint space. In practice the training is performed with a large training dataset of such pairs, illustrated in the diagram as GT (Ground-Truth). The original CLIP model was trained with 400 million of such image-text pairs (more specifically images and their captions) collected form a variety of publicly available sources on the Internet.

One should note that CLIP or ALIGN are not the only two approaches to build joint Visual-Textual vector spaces. However, these two techniques have introduced several advantages that for the first time opened the way for building effective and practical cross-modal retrieval components like the one used in our system. First, CLIP and ALIGN are the first approaches to bridging Computer Vision and Natural Language Processing that can be trained with datasets of image-text pairs that are readily available, without any additional labeling. Secondly, since CLIP and ALIGN were design to learn visual concepts from natural language supervision their joint vector spaces are particularly well suited for representing semantic concepts. Finally, thanks to leveraging semantic information from readily available massive training datasets they have been shown to generalize much better than earlier techniques. In turn this means that components built with these techniques provide acceptable results for new datasets and tasks that differ from the ones used during the training. This last advantage is leveraged in the cross-modal matching component 112 to provide satisfactory results for any new catalogs of parts and progressively improve the results by enrichment and fine-tuning with query data. In some implementations, the CLIP approach can be adapted or modified for spare parts search. The original CLIP model pre-trained as described in [CLIP] does not perform sufficiently well when applied without any change in the domain of enterprise parts search. Therefore, several domain adaptation techniques can be used to improve the performance of the CLIP in the multi-modal parts search engine 102.

Once the CLIP model is adapted to the domain of spare parts, the CLIP model can be used for implementing the cross-modal matching component 112. The Image-To-Text search can be implemented in a very similar way to the Image Matching implementation described earlier. The main difference is that the cross-modal search requires a trained CLIP or ALIGN model capable of embedding query images and catalog textual descriptions (as opposite to image embedding models used for Image Matching capable of solely embed images).

In fact, the cross-modal matching component 112 can be implemented using the same architecture as the one shown in FIG. 3 for Image-Image Matching. The differences lie in methods and models used for extracting query and catalog embeddings. Here, catalog items can be represented by text (i.e., part names) so their embeddings are extracted using Text Embedding (text encoder) from the trained CLIP model. Embeddings representing Query Images are extracted using Visual Embedding (image encoder) from the CLIP model. Another difference is that in the most basic variant of the Image-Text matching, where each catalog part is represented by a single text embedding, the searcher could be fully implemented by the Approximate Nearest Neighbor Searcher functionality (i.e., without any additional matching logic). More complex variants, involving multiple embeddings per part could need an additional matching logic.

As noted earlier, the proposed implementation of the Image-To-Text component provides good basis for extending it to handling multi-modal queries and multi-modal catalog representations. In other words, one could extend the component to perform multi-modal queries composed of an image (or images) and a text, and search within catalogs where parts are represented by text and one or multiple images.

The simplest mechanism for implementing such extensions is based on the compositionality of CLIP and ALIGN embeddings across vision and language domains. This property permits that, given a query image and a text string, we can add their embeddings together and use the sum to retrieve relevant catalog embeddings using cosine similarity. This means that the CLIP-based search component can take as an additional input Query Text elements (as shown with the dashed line in FIG. 1), or entire Query Texts, and the fusion mechanism would seamlessly add its embeddings to the Query Image embedding to improve the ranking quality produced by the component. In fact, such approach leverages the semantic representation capabilities of the CLIP model and seamlessly introduces Semantic Text Search into the system. The same fusion mechanism could be used for generating multi-modal embeddings for catalogs where every part is represented by a text and an image. Handling catalogs that have several images could be implemented by creating one embedding per image, where each of such embeddings would be computed as a sum of the image embedding and the text embedding. However, searching in such catalogs could be implemented in several other ways. For example, the CLIP embeddings representing catalog views could be matched to the Query embeddings as in the image matching component 114 and then the result of the most similar view could be further fused with the query similarity to the text description (e.g., using a late fusion). It should be noted that the above extensions of the Cross-modal component permit using it as an additional source of ranking results even for unimodal queries and catalogs, i.e., Image-To-Image Matching and even Semantic Text Search, that could be then fused with the outputs of the Image Matching and Text Search components.

Extending the joint-space-based component with the abovementioned capabilities may be handled within the system architecture in two distinct ways. One approach is to keep the architecture from FIG. 1, maintaining the specific components for Text Search and Image Matching and perform late fusion of all the search components (including the embedding-based component extended to perform Multi-modal search). This strategy has an advantage of keeping some of the specific benefits of the dedicated Text Search and Image Matching components. But it cannot fully leverage the advantages of the early fusion performed within the joint-space-based component, and to certain extend it still suffers from the typical limitations of late fusion. Another approach is to further optimize the joint embedding model to handle matching of all combinations of modalities, and therefore eliminating the need for a dedicated Text Search and Image Matching components, completely avoiding any late fusion. Such a strategy can fully leverage all advantages of early fusion of query and catalog representations.

The extension of the cross-modal matching component 112 to a Multi-modal Matching involves choosing a strategy for creating multi-modal embeddings representing the catalog items. Possible approaches include catalog part multi-modal data being represented as single multi-modal embeddings. In this approach every catalog part is represented by a single multi-modal embedding combining all data elements from all modalities. Another possible approach includes representing catalog part multi-modal data by multiple embeddings, each embedding being a combination of the text embedding for a particular reference image. In this approach, a single textual embedding is combined with embeddings of each reference image, creating multiple multi-modal embeddings. Storing multiple embeddings per part can be considered during the search. One possible implementation is to compare the query embeddings with all embeddings representing the part and obtain the final similarity as the maximum similarity found among all the embeddings representing the part. Yet another possible approach includes representing catalog part multi-modal data elements by individual embeddings (i.e., separate embeddings for each text element and reference image). In this approach not only every reference image is represented by its own embedding, but also different Query Text elements are represented by individual embeddings. Also, in this approach the multiple embeddings per part can be considered during the search. One possible implementation is to compare the query embeddings with all catalog part embeddings and obtain the final similarity as the maximum similarity found among all the embeddings representing the part.

Referring again to FIG. 1, the multi-modal parts search engine 102 can include a filtering operation performed by a filter 140. With large catalogs, it becomes useful to be able to filter out results based on structured information available in the imported master data source 104. Users capable of applying such filtering criteria can significantly reduce their search space (i.e., reduce the number of parts that need to be searched using other modalities) which often directly translates to much shorter search times.

The most basic and useful form of filtering permits selecting a machine or a submodule of the machine to limit the results to the parts which are assigned to it. This is possible when a customer provides a hierarchical structure of their part data in the form of Bill of Material (BoM). In such structure, every machine is divided into modules and parts. Very often users know to which machine or even submodule belongs a certain part.

The above mechanism can be extended to other types of data, and permit users to filter results based on attributes that are present in master data source 104. Again, the filters require that such information be already structured in the provided master data source 104. One form of providing such information is {key, value}pairs of attributes and attribute values. An example format can include a simple spreadsheet format using columns for attribute keys and rows in each column for attribute values.

It should be noted that a specific key may have empty values for some specific catalog parts. One filtering strategy is to combine selected attributes with AND logical operator and use OR operator to combine filtering values of a given attribute, e.g., if a user selects material=copper, bronze and category=faucet, the results should be parts for which the (key:material=copper OR bronze) AND the key:category=faucet. Such a simple strategy means that result lists will exclude parts that have at least one of the selected attributes missing in the provided master data.

The filtering mechanisms described here can be implemented in several ways. Many modem text search tools and libraries permit the so-called facets or hierarchical facets mechanisms [ELAS]. Also, some Vector Search tools permit filtering attributes when performing Approximate Nearest Neighbor search needed by Image Matching and Image to Text Search [VESP].

To avoid implementing complex filtering logics for every search modality, one could implement a filter 140 that, given selected filter values provided by the user, produces a filtered set of part identifiers (IDs). Such IDs can be then passed to each of the search modules to perform a simple filtering operation e.g., by a post-processing their initial ranked results. Internally, such a dedicated Filtering module would need to store all attributes for every catalog part in a way that facilitates fast filtering. One could implement such structure using an inverted file index storing a mapping from every attribute value to catalog parts that have such value. Filtering with such structure would then require to simply apply logical operators between sets of parts mapped to each selected attribute. It should be noted that many dedicated text search engines [ELAS] could be also used to implement such filtering module that would return IDs of the parts that could be then passed to other search modalities.

It should be noted that filtering can play a role in initial stages of catalog enrichment when other modalities may not be present or contain partial or weaker representations. At such stages, the additional discriminatory power provided by the filters can be useful for successful completion of many search sessions, which in turn lead to obtaining new modalities for the parts confirmed as correct matches.

Moreover, the enrichment mechanism described below could be extended to also enriching structured data used for Filtering. The most useful application is to fill missing attributes values that would then permit correct inclusion of the enriched parts during filtering. The enrichment itself could be implemented by adding detection of specific attributes to the query parsing module 138. Whenever a user successfully finds a part without using filtering with attribute values that this part may be missing, the missing values may be potentially filled if the Query Parser detected their values among Query Text elements.

When searching for parts it can be useful to fuse all search inputs seamlessly, without any need for users to know which modalities are available for the searched parts, or how to combine the results. Such fusion can be handled by the late fusion module 122, which fuses results of Image Matching, Text Search, and Cross-modal Matching. More specifically the module takes as input any combination of ranked lists of catalog parts, and outputs a single list with the fused results (without duplicates).

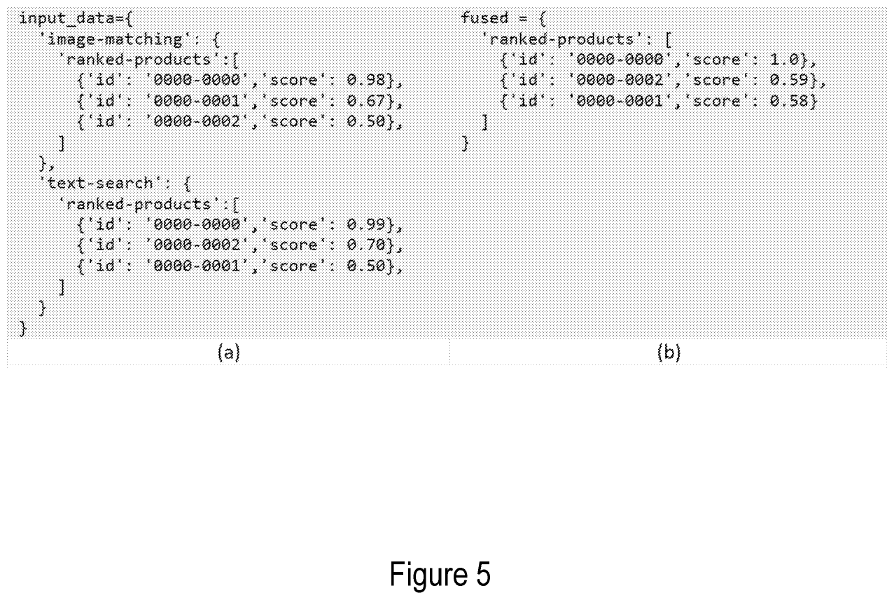

FIG. 5 shows an example late fusion operation. In particular, FIG. 5(a) shows results of text search (‘text-search’) and results of image matching (‘image-matching’) provided by the text search component 110 and the image matching component 114, respectively. FIG. 5(b) shows the late fusion operation, where the results of the text search and the image search are fused without duplication and with updated scores for each product ID.

On the one hand the assumption is that if a catalog part is ranked highly by two or more search modalities, the probability that the part is relevant is extremely high (the so-called “chorus effect”). On the other hand, in our case the late fusion module 122 must also enable adequate ranking of parts ranked highly only by one of the modalities. This second aspect is useful in providing acceptable results when parts may be poorly represented, or not represented at all by all modalities. Finally, to enable reasonable maintainability any Late Fusion should be robust against changes (e.g., fine tuning) of models used in input sources.

The topic of fusion for content-based multimedia information retrieval has been extensively studied in the past [WILK01]. The late fusion module 122 does not depend on any specific fusion approach. In practice, balances between performance and robustness to noisy modalities and data distribution changes may be provided by rank-based methods, where only the rank information is considered, and the scores generated by the different search modalities are ignored. More specifically, a Borda count method can be used followed by Min-Max normalization for fusion of top ranked results [WILK01], while the remaining part of the results are fused using a simple Round Robin strategy.

The Borda count is a voting method, where, for a ranked list of N catalog parts produced for a given search modality, the highest ranked part gets N votes, and each subsequent part gets one vote less. Then, the fusion is performed by adding up the votes obtained by each part from all search modalities being fused. Although effective, the simplest Borda count fusion does not perform well when combining ranked lists of different lengths. An alternative variant of the method first determines what is the size of the largest ranked list to be normalized and uses this value instead of N from which to subtract the current rank. But this in effect creates the opposite problem where short lists, relatively speaking, are having greater impact than longer lists. Therefore, following [WILK01] one can take a middle ground approach where the traditional Borda count method is followed by a normalization of the resulting Borda count values by applying Min-Max normalization. The fusion is performed by summing the normalized counts and sorting. This approach can be referred to as Borda-MM. This variant has the property that all top ranked documents from the ranked lists to be combined will all have the same normalized count of 1, whilst the lowest ranked documents across all sets will have a normalized count of 0. In other words, this approach aligns the strengths of contributions from the top and the bottom of the ranked lists being fused and provides a convenient way to normalize the fused counts to [0,1] range. Finally, the late fusion module 122 can incorporate a simple Round-Robin strategy for fusing the results that have not obtained the highest Borda-MM counts to include parts ranked highly only by some modalities (e.g., some modalities are missing from their catalog data).

In some implementations, the late fusion module 122 can perform the following steps. At stage 1, fuse k-top results using Borda-MM. This stage can include performing Min-Max normalization of the ranks between [0:1] range, e.g., a top ranked part from a given source gets score 1.0, and the last one gets score 0.0. The late fusion module 122 can then rank parts by summing normalized ranks from each source. If any ties result, the late fusion module 122 can resolve the ties based on original input scores. At stage 2, the late fusion module 122 can fuse the remaining input results using a modified round-robin method. In particular, the late fusion module 122, in each round-robin round, gets the next input results that has not been fused yet, re-order the results based on their Borda-MM normalized counts (if available) and add to the output. The late fusion module 122 can continue stage 2 until all input parts are added to the output. It should be noted that one drawback of the late fusion approach is its inability to exploit correlation in the joint feature spaces. One alternative is to perform early fusion or even a hybrid fusion approach where both types of fusion are performed. The multi-modal parts search engine 102 is suitable for including early fusion by leveraging the capability of the joint Visual-Textual embeddings. As indicated in the example multi-modal parts search engine 102 in FIG. 1, some parts of textual queries (drawn with a dotted line) could be routed to the Image-Text Matching module implemented using joint Visual-Textual embeddings. Such implementation of this module allows a straightforward way of performing early Image and Text fusion in the joint space [CLIP], [ALIGN]. In fact, since the joint embedding spaces permit computing embeddings for catalog images, one could drop a separate Image Matching component and perform Image Matching by an early fusion of the catalog Image and Textual information.

As mentioned above, the enrichment module 120 can select the query information suitable and useful for enriching the representation of the confirmed catalog part, extract its representation needed by the search components and update the catalog representation with the new information. As shown in FIG. 1, the enrichment module 120 receives as inputs (i) the search session information (all query modalities provided by the user) together with (ii) the identifier of the confirmed catalog part, and (iii) the representation of the confirmed part available in the catalog database 108 (in some implementation this may include at least some of the embeddings, e.g., Cross-modal Search embeddings) and enriches the confirmed part catalog information.

The enrichment module 120 assesses the quality of the query data and its usefulness for the catalog enrichment by comparing the elements of the query data with the confirmed part representation available in the catalog database. The complexity of the selection logic may vary depending on the preferred enrichment strategy, quality of the confirmations, requirements resulting from specific implementation of the search components, and the richness of the already available information for the confirmed part. Additionally, the enrichment module 120 may perform some data transformations and quality enhancements. Finally, as in the case of the ingestion process, or any catalog addition or update, feature extraction step extracts representation of the selected data elements needed by the search components. In some implementations the extracted features (embeddings) for some modalities (e.g., Cross-modal Search) can be combined with the features (embeddings) representing the catalog data available so far, while in other implementations the new features are kept separately. The selected query data elements and their features are then stored in the catalog database 108 and provided to all search components.

FIG. 6 shows a flow diagram of an example enrichment process 600. The enrichment process 600 can be executed by, for example, the enrichment module 120. The enrichment process 600 includes obtaining all query data elements (textual and visual) logged for search session with a given ID. This includes at least elements of Query Text and the Query Image. In some implementations the original user inputs can be stored as search session logs that include search session identifiers, text queries and filters, and references to captured and stored query images (shown in FIG. 1 as session logs database 136). Therefore, one possible practical implementation of the enrichment module 120 can receive search session identifiers and obtain all related query data elements (textual and visual) logged for the current search session from the session logs database 136. It should be noted that in some implementations the enrichment module 120 can also access Query Text parsing results or/and results of Query Image analysis (e.g., bounding boxes), and such information could be also stored in the session logs database 136.

The enrichment process 600 may also include query data parsing and segmentation. Some search components implementations may not need parsing of textual queries nor provision of position of the part in the query image. But even such implementations often benefit when such information is available for catalog representation. In such cases, such structuring of the user input can be implemented by the enrichment module 120 and can include automatic Query Text Parsing and Query Image Cropping. However, it should be noted that these two Enrichment steps are optional and could be omitted in some implementations.

The enrichment module 120, in the Query Text Parsing step, can annotate Query Text elements with structuring information such as for example ‘serial number’, ‘manufacturer name’, or ‘part category’. The structuring information can represent the field information of a data structure that represents the part in the catalog database 108. The parsing may be implemented in a manner similar to that described in relation to query parsing module 138.

In general, during enrichment the parsing information allows more specific alignment of Query Text elements with the structured catalog representation, e.g., detecting manufacturer name allows to enrich the corresponding field in the catalog. This is turn opens possibilities for specific weighting when these elements are matched by the Text Search component. Another way of leveraging such structuring information is encoding the identified text entities within Cross-modal embeddings. Some other implementations may represent some of such annotated elements with a separate embedding.

Knowing the position of the part in the query image permits using for enrichment only the region representing the part and ignoring unrelated background objects that could introduce noise to the catalog representation. Before being added to the catalog the enrichment module 120 can crop the query image according to bounding boxes provided during the search session by the users or according to automatic detection or segmentation performed as part of the search. If none of these are generated during the search session, such processing can be performed within the enrichment module 120. Such cropping can be performed at the bounding box level (e.g., [GIR14]), or using a segmentation approach (e.g., [CHE20]) that in addition to cropping also permits masking irrelevant background objects on the pixel level. Moreover, one could use segmentation techniques capable of leveraging the name and description of the confirmed part to guide the part segmentation, e.g., using a segmentation approach from Natural Language Expressions [HU16].

The enrichment process 600 also includes selection of query data elements (e.g., text modality or image modality) for inclusion in the catalog database 108. One enrichment approach could include incorporating all data from confirmed queries into the catalog. An extension of this approach would be to label such information as coming from past user queries so the search components can incorporate any matches of such data in an appropriate way (e.g., matching catalog representations originating from the query enrichment could be weighted down as compared to ingested catalog representations).

Another approach is to further curate the query data elements in an automatic or/and manual way to ensure novelty and quality of the enrichment. Limiting the enrichment to a higher quality data permits stronger reliance on such data during the search. Ensuring novelty helps correct incorporation of the information when searching, i.e., indiscriminative repetition of the same textual data can affect certain representations. The selection can be based on certain criteria. For example, the enrichment module 120 may select a query data element if it is novel. Novelty criterion aims at enriching the confirmed catalog part only with data that is novel when compared to the existing representation. This criterion ensures that the catalog representation is enriched only with novel data elements and prevents adding duplicate or very similar elements. As an example, a novelty score can be determined based on a similarity score of the query data elements with respect to the modalities stored in the catalog database 108 associated with the one or more matches. Selection criteria can also include quality of the query data elements. This criteria ensures that only high-quality data elements are selected for enrichment. Another criteria can include uniqueness or information richness. This criterion ensures that the selected data elements contain discriminatory information. This can be based on either analyzing the amount of information present in each element, or by matching the element to the representations already present in the catalog and selecting it for enrichment only if no parts unrelated to the confirmed part match with a predefined similarity. Another criterion can include confirmation by manual inspection on the element level. Multi-modal search permits finding parts even when matching only some query elements. This means that enrichment based on confirmations performed on the parts level may introduce into part representations elements that are irrelevant. Therefore, some implementations may include an additional manual inspection step confirming the suitability of each individual query element for the enrichment. Moreover, in some implementation such manual inspection can be facilitated by visualizing the results of automatic estimation of the novelty, quality, and uniqueness processing steps. Such inspection has much lower speed constrains and can be performed offline.

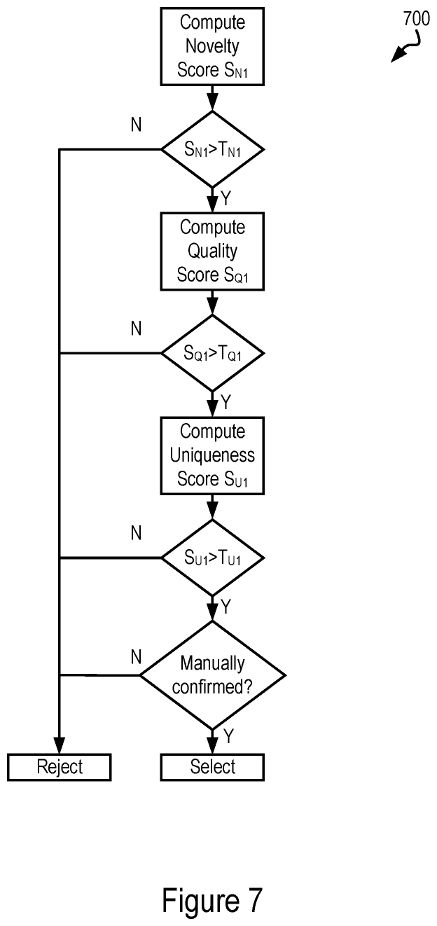

FIG. 7 shows a flow diagram of an example rule-based selection process 700 for enrichment. Each of the automatic selection criteria starts by computing a score and is followed by a comparison with a threshold. For example, novelty score (S_{N1}), quality score (S_{Q1}) and uniqueness score (S_{U1}) are compared to a novelty threshold (T_{N1}), quality threshold (T_{Q1}) and uniqueness threshold (T_{U1}), respectively. If all the scores are greater than the corresponding threshold value, and if the modality is manually confirmed, the modality can be selected for enrichment. In some examples, the manual confirmation can be ignored or not carried out. The quality score S_{N1} can represent the quality of the image. As an example, a blurred image may have a quality score that is less than the threshold value. The criteria are applied sequentially. However, the order in which the scores are determined can be different than the one shown in FIG. 7. In addition, in some examples, selection (or rejection) can be based on fewer scores than those depicted in FIG. 7. With such an approach one can implement several criteria capturing related data aspects, e.g., one could use several image quality criteria applied sequentially. The thresholds controlling the selection could be set based on e.g., the required level of false positive selections (percentage of selected data element samples that should be rejected). If explicit control of the selection process is not desired, the automatic selection criteria from the above selection could be implemented as binary classifiers dividing data elements into two classes: suitable or unsuitable for enrichment. Such classifiers could be trained in a supervised manner based on annotated examples of query data elements. In such case the abovementioned selection criteria could be translated into annotation instructions to collect the required training data.

Referring again to the rule-based selection process 700, The novelty criteria for images aims at selecting query images only if they represent new viewpoints or appearances. This may be implemented by comparing query images with images already representing the confirmed part. The comparison can be performed by any Image Matching technique. But the most suitable method is the one used for the implementation of the image matching component 114 since it reflects best the similarity criteria used during the search.

The query image is accepted for enrichment if its similarity to any of the catalog images already representing the confirmed part is not higher than a predefined threshold. Otherwise, the query image is rejected. To ensure enrichment with high quality query images one can implement an automatic estimation of various quality measures such as image blur, noise, or compression artefacts. Many of such quality measures can be estimated using Deep Learning Neural Networks by including a regression layer at the end of the network (e.g. [YAN16]). A query image is accepted for enrichment only if a given quality score satisfies a criterion such as, for example, that the quality score is higher than a predefined threshold. Other quality measures include computing confidence that a Query Image depicts parts that are packaged or are visualized on a display screen. This can be implemented by training Deep Learning binary classifiers and using their confidence scores as quality measures.

One straightforward way to establish whether an image depicts visual features potentially useful for distinguishing parts is to perform edge detection and calculate the ratio of regions with edges to a untextured areas of the image. Images without edges (i.e., low ratio) can be then rejected from enrichment. Such procedure prevents enrichment with images showing predominantly uniform areas. Another approach is to ensure that the image candidate does not match many catalog images representing parts unrelated to the one being enriched. The image matching can be performed using either the image matching component 114 or the cross-modal matching component 112. The detection of unrelated parts can be performed by thresholding similarities between parts computed using the same approach as the one used for Image-To-Text search. Another approach to implementing this criterion finds a set of catalog items that are most similar to the Query Image based on their catalog images and then computes semantic similarities (e.g., Text-To-Text matching using e.g., [CLIP]) between the parts within that set. The criteria for accepting Query Image as uniquely representing one category can be based on comparing some statistics of these similarities (e.g., mean and standard deviation) with predefined thresholds, e.g., very high standard deviation of semantic similarities indicates heterogenous neighborhood of parts and are good indicator that a Query Image in question cannot distinguish between them.

In some implementations the parameters controlling the selection can be dynamically adjusted based on the number of images already representing the part. In other words, the more images already represent the part, the stricter the enrichment criteria.

In some implementations an automatic confirmation of the query image could be added to the selection process by accepting only query images that are sufficiently similar to the catalog part according to the Cross-modal Matching (i.e., cosine similarity below a predefined threshold). Such mechanism avoids enrichment with Query Images that are query specific and have not contributed in positive way to finding the part.

In some implementations, the enrichment module 120 can compute novelty scores for each textual element as ratios of consecutive characters that were not matched with catalog representations. Another implementation of the novelty criterion is based on defining an edit distance (e.g., Levenshtein edit distance) above which a text element is considered novel. Only textual elements with sufficient novelty scores are accepted by the enrichment module 120 for enrichment. In some implementations, the Query Text parsing information is used to compare query elements only to the part of catalog representation corresponding to the same text entities, e.g., query elements annotated as ‘part category’ are compared only with catalog representation corresponding to ‘part category.’ This allows more specific and precise comparisons needed to establish novelty. The approach can be further refined by a more advanced way of comparing text representing quantities. Specifically, one can normalize attribute units before the comparison. This could be implemented by using regular expressions for the detection of the most common units. The detected attributes with units are normalized to a default unit defined for a given attribute type. Since the above criteria may introduce noise to the catalogue representation, in some implementations the selected enrichment candidates can be further confirmed by manual inspection.

Referring again to FIG. 6, the enrichment process 600 includes feature extraction of the selected query data elements and optional embeddings combination. Such features need to be generated for every search component in the multi-modal parts search engine 102, i.e., for Text Search, Image Matching and Cross-modal Matching. As a result, after this stage the original data, the extracted features, and in the case of the Cross-modal matching also updated combinations of existing and new features, are stored in the catalog database 108, as shown in FIG. 1. The updated representations are then provided to the corresponding search components.

The complexity of the feature extraction and their combination with features of existing representations varies depending on the search component that is using the data. Implementation of a Text Search component may include appending the textual query elements selected for enrichment into the correct data field in the catalog database 108. While Cross-modal Matching can include extraction of embeddings for each modality used in the enrichment and their combination with embeddings of the existing catalog representation.

An example implementation of Text Search component may include appending the textual query elements selected for enrichment into the correct data field in the catalog database 108. This data field can be generic, e.g., ‘part name’ or ‘short part description’ or specific based on the text element type extracted via the automatic Query Text parsing (examples may include ‘ID’ (identifier), ‘manufacturer name,’ or ‘part category’). The new data is added to the Catalog Database and then sent to the Text Search component. In some implementations the Text Search component may perform a further indexing that facilitates rapid retrieval.

An example implementation of the image matching component 114 uses global image features (embeddings) extracted using Deep Learning Neural Networks (i.e., the output of the last Neural Network layer can be used as the global image features). The image matching component 114 can be implemented by representing every reference image with its own feature vector (embedding). Therefore, enriching the catalog with a new Query Image and enabling it for Image Matching can include extracting its image embedding using the image matching feature extractor 206 and adding the image and its embedding to the catalog database 108. More specifically, the new image embeddings are added to the already existing set of Image Matching embeddings representing the part being enriched. The image embeddings are then sent to the image matching component 114 and made available for search.

The enrichment module 120 can also extract features for cross-modal matching enrichment. Since the Cross-modal Matching component can leverage catalog images and textual representations, every query element selected for enrichment requires extraction of the corresponding features (embeddings) and their combination with the embeddings of the already existing representations.

Embeddings of the Query Text elements selected for enrichment are obtained by the Text Encoder, while embeddings of the Query Image are obtained by the Visual Encoder. The combination of these new embeddings depends on the involved elements from each modality, and the approach taken to represent multiple data elements belonging to each modality.

In some instances, the multi-modal data associated with a part in the catalog is represented as single multi-modal embeddings. Every time new query data element is selected for enrichment, its embedding is extracted using the corresponding CLIP or ALIGN encoder and added to the corresponding single embedding.

In some instances, the catalog part multi-modal data can be represented by multiple embeddings, where each embedding can be a combination of the text embedding and embedding for a particular reference image. That is a single text embedding is combined with embeddings for each reference image associated with the part. Every embedding representing a part is created by adding the embeddings of the textual information and embeddings of a specific reference image. It should be noted that in this scenario, adding a new textual element involves adding its embeddings to every multi-modal embeddings representing a part in the catalog, while adding a new image involves only creation of a single multi-modal embeddings combining the text embeddings and the embeddings of the image being added. For sake of efficiency, some implementations may also store the textual embeddings to avoid its re-generation with every image addition. Storing multiple embeddings per part may also be considered during the search. One possible implementation is to compare the query embeddings with all embeddings representing the part and obtain the final similarity as the maximum similarity found among all the embeddings representing the part.

In some instances, the catalog part multi-modal data elements can be represented by individual embeddings. That is, separate embeddings are stored for each text element and for each reference image. In this approach not only every reference image is represented by its embeddings, but also different Query Text elements are represented by individual embeddings. In this scenario the enrichment module 120 produces new individual embeddings for every new query element, and they are added to the existing set of embeddings already representing the part being enriched. In this approach storing multiple embeddings per part may also be considered during the search. One possible implementation is to compare the query embeddings with all catalog part embeddings and obtain the final similarity as the maximum similarity found among all the embeddings representing the part.

When creating multi-modal embeddings for search system 100 like the ones discussed above, it can be beneficial to address the so-called modality gap present in deep learning models such as CLIP trained with contrastive loss [LIA22]. In some implementations, the modality gap can be addressed by shifting all image-only and text-only embeddings. For example, a large dataset of image-text pairs representing parts can be used and mean embeddings for images, text samples, and their multi-modal combinations can be computed by simple addition. Subsequently, all image-only and text-only embeddings can be shifted in such a way that their mean values are equal to the mean multi-modal embeddings combined by addition.

The catalog enrichment mechanism discussed herein permits adding data from new modalities (textual, visual or their combinations) that may not have existed a priori in the catalog. As a result, each new query element that is added to the catalog can potentially improve the accuracy of consecutive searches. As explained herein, this effect is achieved by direct incorporation of the new data elements selected from successful user queries (with respect to improving accuracy of the text search component), and via incorporation of image and textual embeddings into the catalog representation (with respect to improving accuracy of image matching and cross-modal matching components). When compared to a unimodal enrichment approaches the described method has a compounding effect on the enrichment data and accuracy improvements. More specifically, it provides a clear incentive to users to add query elements regardless of the presence of certain modalities in the catalog. This in turn leads to higher rate of catalog enrichment, and a higher rate of search performance improvements for a given number of search sessions. Moreover, the higher rate of performance improvements comes from both: catalog data getting richer faster, and faster growth of the training dataset.

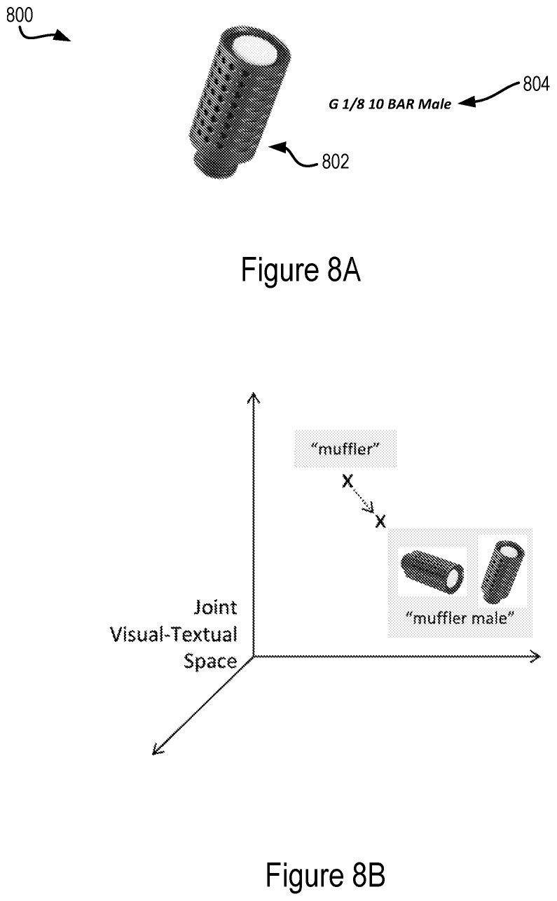

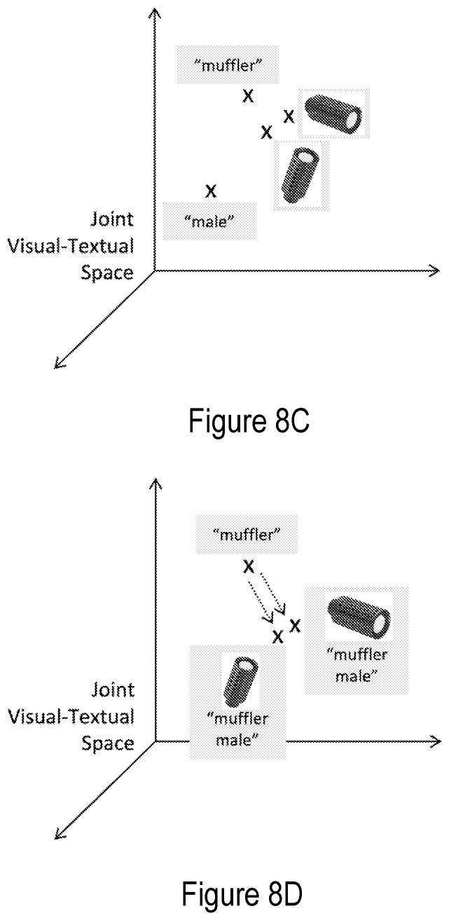

FIGS. 8A-8D describe example embeddings corresponding to catalog enrichment. FIG. 8A shows an example search query 800 including a search query image 802 and a search query text 804. The search query 800 includes both an image modality and a text modality. The search query image 802 includes a captured image of a spare part (e.g., a muffler) and the search query text 804 includes the text “G ⅛ 10 BAR Male,” purportedly identifying the part captured in the search query image 802. The search query image 802 can be provided to the image matching component 114 and the cross-modal matching component 112, while the search query text 804 can be provided to the text search component 110. Even if the catalog database 108 were to not include any images that match the search query image 802, the cross-modal matching component 112 and the text search component 110 can generate ranked list of parts whose text descriptions match the search query image 802 and the search query text 804. A combination of the results produced by the cross-modal matching component 112 and the text search component 110 can provide the user a list of matched parts from the catalog database 108.

Assuming the user selects a part labeled “Muffler G ⅛ 10 BAR” from the ranked list, and/or a part is confirmed by the part confirmation module 118, the part can be used for enriching the catalog database 108. The enrichment module 120 can compare the search query text 804 and the search query image 802 with the modalities currently associated with the part labeled “Muffler G ⅛ 10 BAR” and stored in the catalog database 108. Based on the comparison, the enrichment module 120 can determine that the catalog database 108 does not include the word “Male” and the search query image 802. The enrichment module 120 can update the catalog database 108 with the search query image 802. The enrichment module 120 can also update the catalog database 108 with the text “Male”. In addition, or in the alternative, the enrichment module 120 can extract embeddings of at least the search query image 802 and the text “Male,” and update the catalog database 108 with the embeddings. In this manner the enrichment module 120 updates the data associated with the part “Muffler G ⅛ 10 BAR” with a new image sourced from the search query image 802, new text, or the embeddings of the text and image modalities. Subsequent searches with query images depicting the part or query test containing the word “Male” would correctly rank the part higher. FIGS. 8B-8D show depictions of example enrichment processes in a joint visual-textual space. In particular, FIG. 8B shows the catalog part named “muffler” is enriched with one or more queries that include two query images depicting the muffler and the text “male.” FIG. 8C depicts an enrichment example where multi-modal data for each catalog part is represented as single multi-modal embeddings. There is an embedding each for the word “muffler,” the word “male” and an embedding each for the two query images. FIG. 8C depicts an enrichment example where multi-modal data elements are represented by individual embeddings (i.e., separate embeddings for every text element and reference image).

As mentioned above, the described enrichment mechanism can be applied also to queries containing multiple query images. The search can be implemented either by representing the query with a single embedding obtained by adding the individual image embeddings and, if present, query text embeddings. Alternatively, one could create multiple query embeddings, each obtained by adding query text embeddings with one of the query image embeddings. Then, each of the embeddings could be passed to the cross-modal matching component 112 to produce a ranked list of results. The lists obtained for each query embeddings could be then fused using for example the late fusion module 122. The enrichment could be carried out as discussed above. Every query image can be considered separately for the enrichment. The above mechanism can be easily adapted to queries containing query videos by extracting key-frames (e.g., [LIU12], [JAD20]) and using them in the same way as in the case of queries with multiple query images.

In some instance, the query text can be a machine transcribed speech. For example, the user, instead of entering the query text on a device user interface, can audibly provide the name or information of the part the user is searching. A software transcription of the audio can generate the text query, which can be provided to the multi-modal parts search engine 102.

In some implementations, the enriching query elements may be stored separately depending on the type of the provided confirmation. In some instances, the enriching query elements can be stored with an indication of the associated degree of confirmation. In this way, consecutive searches may incorporate the information about the confirmation strength (i.e., level of noise) into the ranking process. For example, when a confirmation information is significantly noisier (e.g., an indication of a weak confirmation) than the original catalog data the enriched information can be stored separately from the original representation or the enriched information can be stored with an indicator or a tag that the enriched information is associated with weak conformation. For enrichment elements that do not receive a weak confirmation indication, those enrichment elements may be stored in the catalog database 108 without any associated confirmation indicators or stored with an indicator or a tag that denotes strong confirmation. This permits to give lower weights to matches involving representations created from the noisy or weak confirmations. Such mechanism of storing separately, or separately indicating, some of the enrichment data can still be implemented using the different approaches to storing multi-modal embeddings. One possible approach is to introduce a separate multi-modal embeddings for every type or strength of confirmation (note that several types of confirmation may have similar levels of noise). Therefore, each of the approaches to storing and updating multi-modal embeddings described earlier could be applied. Another approach to incorporating the confirmation strength when creating multi-modal embeddings is to replace the addition operation used for computing multi-modal embeddings with a weighted sum, where the weighting reflects the strength of the confirmation strength.

In some implementations, enrichment of the catalog database 108 can be based on input from the entity providing the search request. For example, an input from a user that provided the part request can be used to substitute or augment any expert conformation. Once a catalog part is presented to the user in response to the part request, the search system 100 can provide the user an interface that can elicit additional information from the user. The interface can include an on-screen user interface including check boxes, thumbs-up icons, etc. The user interface can query the user as to the level of confidence the user has on the catalog part result matching the part request. The search system 100 can receive the user input from the user interface and if the user inputs high confidence on the catalog part result matching the part request, the search system 100 can incorporate the catalog part result into the catalog database 108 to enrich the catalog database 108.

The search system 100 can enrich the catalog database 108 based on crowdsourcing. In particular, the search system 100 can permit all or a certain group of users (e.g., expert users) to provide additional data (e.g., images or text) to enrich the catalog database 108 with information on parts that they found using the search engine. This additional information could then follow the catalog database 108 enrichment steps described above. In other words, even if the search system 100 allows to find parts in catalogs with incomplete and low-quality data, the search system 100 can permit users to provide additional information that could then be used to enrich the identified parts. This way subsequent searches for these catalog parts would be faster. Referring to FIG. 1, the part confirmation module 118 can allow a group of users or experts to provide additional data in relation to the search query and the corresponding catalog part generated by the multi-modal parts search engine 102. The part confirmation module 118 can provide the additional part information provided by the group of users to the enrichment module 120 to enrich the catalog database 108. It should be noted that it is optional that this additional enrichment information includes the original query elements that were used to find the part. In other words, once the users find the part, they can choose to provide a different enrichment data for the part, e.g., data with higher quality or complementing the current catalog data better than the query elements that were used to find the part.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

References: All cited references, patent or literature, are incorporated by reference in their entirety. The examples disclosed herein are illustrative and not limiting in nature. Details disclosed with respect to the methods described herein included in one example or embodiment may be applied to other examples and embodiments. Any aspect of the present disclosure that has been described herein may be disclaimed, i.e., exclude from the claimed subject matter whether by proviso or otherwise.
[ASAPT] Amazon Shopping—ASIN Product Type
[ASCP] Amazon Shopping—Guidelines for classifying products.
[SADEH19] Sadeh, Gil and Fritz, Lior and Shalev, Gabi and Oks, Eduard, “Joint Visual-Textual Embedding for Multimodal Style Search”, 2019 (https://arxiv.org/pdf/1906.06620.pdf).
[CLIP] Alec Radford, Ilya Sutskever, Jong Wook Kim, Gretchen Krueger, Sandhini Agarwal, “CLIP: Connecting Text and Images”, 2021 (https://arxiv.org/abs/2103.00020).
[ALIGN] Chao Jia, Yinfei Yang, Ye Xia, Yi-Ting Chen, Zarana Parekh, Hieu Pham, Quoc V. Le, Yun-Hsuan Sung, Zhen Li, Tom Duerig, “Scaling Up Visual and Vision-Language Representation Learning With Noisy Text Supervision.”, CoRR, 2021 (https://ai.googleblog.com/2021/05/align-scaling-up-visual-and-vision.html)
[DESH] Adit Deshpande, “The 9 Deep Learning Papers You Need To Know About (Understanding CNNs Part 3)” (https://adeshpande3.github.io/The-9-Deep-Learning-Papers-You-Need-To-Know-About.html).
[Portillo21] Jesus Andres Portillo-Quintero, et. al., “A Straightforward Framework for Video Retrieval Using CLIP” (https://arxiv.org/abs/2102.12443).
[Wu21] Xingjiao Wu et. al., “A Survey of Human-in-the-loop for Machine Learning” (https://arxiv.org/abs/2108.00941).
[Genger21] Gorkem Genger, “In-Depth Guide to Human in the Loop (HITL) Machine Learning” (https://research.aimultiple.com/human-in-the-loop/).
[Bisen20] Vikram Singh Bisen, “What is Human in the Loop Machine Learning: Why & How Used in AI?” (https://medium.com/vsinghbisen/what-is-human-in-the-loop-machine-learning-why-how-used-in-ai-60c7b44eb2c0).
[appen] https://appen.com/blog/human-in-the-loop/
[MING19] Mingxing Tan and Quoc V. Le., “EfficientNet: Rethinking Model Scaling for Convolutional Neural Networks.”, ICML 2019 (https://arxiv.org/abs/1905.11946).
[LIU21] Ze Liu, Yutong Lin, Yue Cao, Han Hu, Yixuan Wei, Zheng Zhang, Stephen Lin and Baining Guo., “Swin Transformer: Hierarchical Vision Transformer using Shifted Windows.” (https://arxiv.org/abs/2103.14030)
[CHEN21] Wei Chen, Yu Liu, Weiping Wang, Erwin M. Bakker, Theodoros Georgiou, Paul W. Fieguth, Li Liu, Michael S. Lew, “Deep Image Retrieval: A Survey”, IEEE TPAMI, 2021 (https://arxiv.org/abs/2101.11282).
[DUBE20] Shiv Ram Dubey, “A Decade Survey of Content Based Image Retrieval using Deep Learning”, IEEE TCSVT, 2020 (https://arxiv.org/abs/2012.00641).
[MALK18] Yury A. Malkov and Dmitry A. Yashunin, “Efficient and robust approximate nearest neighbor search using hierarchical navigable small world graphs”, IEEE Transactions on Pattern Analysis and Machine Intelligence, 2018 (https://arxiv.org/abs/1603.09320).
[hnswlib] https://github.com/nmslib/hnswlib
[ELAS] Elasticsearch (https://www.elastic.co/elasticsearch/)
[VESP] VESPA (https://docs.vespa.ai/)
[WILK01] Peter Wilkins, “An Investigation Into Weighted Data Fusion for Content-Based Multimedia Information Retrieval”, Ph.D. Thesis, Dublin City University2009 (https://core.ac.uk/download/pdf/11309186.pdf).
[YAN16] R. Yan and L. Shao, “Blind Image Blur Estimation via Deep Learning,” in IEEE Transactions on Image Processing, vol. 25, no. 4, pp. 1910-1921, April 2016
[US20200193552A1] “Sparse learning for computer vision”, publication date 2020 Jun. 18. Note: the abandoned application was included in an omnibus U.S. application Ser. No. 16/99553.
[GIR14] R. Girshick, J. Donahue, T. Darrell, and J. Malik., “Rich Feature Hierarchies for Accurate Object Detection and Semantic Segmentation”, 2014 IEEE Conference on Computer Vision and Pattern Recognition (CVPR), page 580-587. (June 2014) (https://arxiv.org/pdf/1311.2524.pdf).
[CHE20] Zuyao Chen, Qianqian Xu, Runmin Cong, Qingming Huang, “Global Context-Aware Progressive Aggregation Network for Salient Object Detection”, AAAI 2020 (https://arxiv.org/abs/2003.00651).
[HU16] R. Hu, M. Rohrbach, T. Darrell, “Segmentation from Natural Language Expressions”, in ECCV, 2016 (https://arxiv.org/abs/1603.06180).
[CAR21] Mathilde Caron, Hugo Touvron, Ishan Misra, Herve Jdgou, Julien Mairal, Piotr Bojanowski, Armand Joulin, “Emerging Properties in Self-Supervised Vision Transformers”, CoRR (https://arxiv.org/abs/2104.14294).
[MU21] Norman Mu, Alexander Kirillov, David Wagner, Saining Xie, “SLIP: Self-supervision meets Language-Image Pre-training”, CoRR (https://arxiv.org/abs/2112.12750).
[LIU12] Huayong Liu, Lingyun Pan and Wenting Meng, “Key frame extraction from online video based on improved frame difference optimization,” 2012 IEEE 14th International Conference on Communication Technology, 2012, pp. 940-944, doi: 10.1109/ICCT.2012.6511333.
[JAD20] S. Jadon and M. Jasim, “Unsupervised video summarization framework using keyframe extraction and video skimming,” 2020 IEEE 5th International Conference on Computing Communication and Automation (ICCCA), 2020, pp. 140-145, doi: 10.1109/ICCCA49541.2020.9250764.
[LIA22] Weixin Liang, Yuhui Zhang, Yongchan Kwon, Serena Yeung, James Zou, “Mind the Gap: Understanding the Modality Gap in Multi-modal Contrastive Representation Learning”, arXiv preprint arXiv:2203.02053 (https://arxiv.org/abs/2203.02053).

The following listing of example aspects is supported by the disclosure provided herein.

Aspect 1: A method, comprising: receiving a first search query associated with searching products, the first search query having a first set of modalities; generating matches based on a cross-modal search using a machine learning model trained to search for matches in a products catalog that match the first search query, wherein matches in the products catalog have a second set of modalities; receiving an indication that one or more of the matches from the products catalog is a confirmed match to the first search query; responsive to receiving the indication, extracting embeddings, based on a neural network, of at least one modality of the first set of modalities of the first search query; updating the one or more matches from the products catalog with at least one of the extracted embeddings and the first search query; receiving a second search query associated with searching products; and generating matches based on a cross-modal search using the machine learning model trained to search for matches in the products catalog that has been updated with the extracted embeddings and the first search query.

Aspect 2. The method of any one of the Aspects 1-18, wherein the first set of modalities includes a text modality and an image modality.

Aspect 3. The method of any one of the Aspects 1-18, wherein the first set of modalities includes an image modality, and the second set of modalities includes a text modality, and wherein the extracting embeddings includes extracting embeddings of the image modality of the first search query.

Aspect 4. The method of any one of the Aspects 1-18, wherein the first set of modalities and the second set of modalities are distinct.

Aspect 5. The method of any one of the Aspects 1-18, wherein the first set of modalities includes text modality, the method further comprising: annotating text of the first search query with structuring information related to the one or more matches in the product catalog prior to updating the one or more matches from the products catalog with the extracted embeddings.

Aspect 6. The method of any one of the Aspects 1-18, wherein the first set of modalities includes image modality, the method further comprising: segmenting, based on a neural network, portions of at least one image included in the first search query that include products, cropping the at least one image to segmented portions of the at least one image prior to extracting embeddings.

Aspect 7. The method of any one of the Aspects 1-18, wherein the first set of modalities include image modality, the method further comprising: determining, using an image matching neural network, a similarity score for the image modality of the search query with respect to each of a plurality of images associated with the one or more matches satisfies a criterion indicating that the image modality is dissimilar; and storing the image modality of the search query in the products catalog in association with the one or more matches.

Aspect 8. The method of any one of the Aspects 1-18, wherein the first set of modalities include image modality, the method further comprising: determining that a quality measure based on at least one of image blur, image noise, or compression artifacts, of the image modality of the search query satisfies a criterion; and storing the image modality of the search query in the products catalog in association with the one or more matches.

Aspect 9. The method of any one of the Aspects 1-18, wherein the first set of modalities include image modality, the method further comprising: identifying a number of regions within an image associated with the image modality; determining a first number of regions within the number of regions that include edges and a second number of regions within the number or regions that do not include edges; storing the image modality of the search query in the products catalog in association with the one or more matches based on a determination that a ratio of the first number of regions to the second number of regions is greater than a threshold value.

Aspect 10. The method of any one of the Aspects 1-18, wherein the first set of modalities includes image modality, the method further comprising: determining, based on image matching or cross-modal matching, a set of data, including texts or images, in the products catalog that most similar to the image modality; determining semantic similarities between members of the set of data; determining at least one statistic including mean or standard deviation of the semantic similarities; storing the image modality of the search query in the products catalog in association with the one or more matches based on a determination that the at least one statistic satisfies a criterion.

Aspect 11. The method of any one of the Aspects 1-18, wherein the criterion is a function of a number of images in the products catalog associated with the one or more matches.

Aspect 12. The method of any one of the Aspects 1-18, wherein the first set of modalities includes text modality, the method further comprising: determining a novelty score for the text modality, the novelty score based on comparison of the text modality with text stored in the products catalog in association with the one or more matches; storing the text modality of the search query in the products catalog in association with the one or more matches based on a determination that the novelty score is greater than a threshold value.

Aspect 13. The method of any one of the Aspects 1-18, wherein the first set of modalities includes image modality, the method further comprising: extracting embeddings, based on the neural network, of the image modality; and adding the embeddings of the image modality to pre-existing embeddings of other images associated with the one or more matches.

Aspect 14. The method of any one of the Aspects 1-18, wherein the first set of modalities includes a combination of image modality and text modality and wherein for the one or more matches, the products catalog includes a pre-existing single multi-modal embedding, the method further comprising: extracting text embeddings corresponding to the text modality and extracting image embeddings corresponding to the image modality, adding the text embeddings and the image embeddings to the pre-existing single multi-modal embeddings of associated with the one or more matches.

Aspect 15. The method of any one of the Aspects 1-18, wherein for the one or more matches, the products catalog includes a plurality of multi-modal embeddings, each multi-modal embedding of the plurality of multi-modal embedding representing a combination of a text embedding and an image embedding, wherein the first set of modalities includes text modality, the method further comprising: extracting text embeddings corresponding to the text modality; and adding the text embeddings to each multi-modal embedding of the plurality of multi-modal embeddings.

Aspect 16. The method of any one of the Aspects 1-18, wherein for the one or more matches, the products catalog includes a plurality of multi-modal embeddings, each multi-modal embedding of the plurality of multi-modal embedding representing a combination of a text embedding and an image embedding, wherein the first set of modalities includes image modality, the method further comprising: extracting image embeddings corresponding to the image modality; and generating a new multi-modal embedding by adding the image embeddings corresponding to the image modality to the text embedding.

Aspect 17. The method of any one of the Aspects 1-18, wherein for the one or more matches, the products catalog includes a plurality of separate image embeddings and text embeddings, wherein the first set of modalities includes text modality and image modality, the method further comprising: extracting image embeddings form the image modality and text embeddings form the text modality, storing the image embeddings form the image modality and the text embeddings from the text modality in association with the one or more matches in the products catalog.

Aspect 18. The method of any one of the Aspects 1-18, wherein receiving the indication that one or more of the matches from the products catalog is a confirmed match to the first search query includes receiving an indication of a weak confirmation that one or more of the matches from the products catalog is confirmed match to the first search query, the method further comprising: updating the one or more matches from the products catalog with at least one of the extracted embeddings and the first query search with a weak confirmation indicator.

Aspect 19. A non-transitory computer readable storage medium storing instructions, which when executed by one or more processors causes the one or more processors to execute a method, comprising: receiving a first search query associated with searching products, the first search query having a first set of modalities; generating matches based on a cross-modal search using a machine learning model trained to search for matches in a products catalog that match the first search query, wherein matches in the products catalog have a second set of modalities; receiving an indication that one or more of the matches from the products catalog is a confirmed match to the first search query; responsive to receiving the indication, extracting embeddings, based on a neural network, of at least one modality of the first set of modalities of the first search query; updating the one or more matches from the products catalog with at least one of the extracted embeddings and the first search query; receiving a second search query associated with searching products; and generating matches based on a cross-modal search using the machine learning model trained to search for matches in the products catalog that has been updated with the extracted embeddings and the first search query.

Aspect 20. The non-transitory computer readable storage medium of any one of the Aspects 19-36, wherein the first set of modalities includes a text modality and an image modality.

Aspect 21. The non-transitory computer readable storage medium of any one of the Aspects 19-36, wherein the first set of modalities includes an image modality, and the second set of modalities includes a text modality, and wherein the extracting embeddings includes extracting embeddings of the image modality of the first search query.

Aspect 22. The non-transitory computer readable storage medium of any one of the Aspects 19-36, wherein the first set of modalities and the second set of modalities are distinct.

Aspect 23. The non-transitory computer readable storage medium of any one of the Aspects 19-36, wherein the first set of modalities includes text modality, the method further comprising: annotating text of the first search query with structuring information related to the one or more matches in the product catalog prior to updating the one or more matches from the products catalog with the extracted embeddings.

Aspect 24. The non-transitory computer readable storage medium of any one of the Aspects 19-36, wherein the first set of modalities includes image modality, the method further comprising: segmenting, based on a neural network, portions of at least one image included in the first search query that include products, cropping the at least one image to segmented portions of the at least one image prior to extracting embeddings.

Aspect 25. The non-transitory computer readable storage medium of any one of the Aspects 19-36, wherein the first set of modalities include image modality, the method further comprising: determining, using an image matching neural network, a similarity score for the image modality of the search query with respect to each of a plurality of images associated with the one or more matches satisfies a criterion indicating that the image modality is dissimilar; and storing the image modality of the search query in the products catalog in association with the one or more matches.

Aspect 26. The non-transitory computer readable storage medium of any one of the Aspects 19-36, wherein the first set of modalities include image modality, the method further comprising: determining that a quality measure based on at least one of image blur, image noise, or compression artifacts, of the image modality of the search query satisfies a criterion; and storing the image modality of the search query in the products catalog in association with the one or more matches.

Aspect 27. The non-transitory computer readable storage medium of any one of the Aspects 19-36, wherein the first set of modalities include image modality, the method further comprising: identifying a number of regions within an image associated with the image modality; determining a first number of regions within the number of regions that include edges and a second number of regions within the number or regions that do not include edges; storing the image modality of the search query in the products catalog in association with the one or more matches based on a determination that a ratio of the first number of regions to the second number of regions is greater than a threshold value.

Aspect 28. The non-transitory computer readable storage medium of any one of the Aspects 19-36, wherein the first set of modalities includes image modality, the method further comprising: determining, based on image matching or cross-modal matching, a set of data, including texts or images, in the products catalog that most similar to the image modality; determining semantic similarities between members of the set of data; determining at least one statistic including mean or standard deviation of the semantic similarities; storing the image modality of the search query in the products catalog in association with the one or more matches based on a determination that the at least one statistic satisfies a criterion.

Aspect 29. The non-transitory computer readable storage medium of any one of the Aspects 19-36, wherein the criterion is a function of a number of images in the products catalog associated with the one or more matches.

Aspect 30. The non-transitory computer readable storage medium of any one of the Aspects 19-36, wherein the first set of modalities includes text modality, the method further comprising: determining a novelty score for the text modality, the novelty score based on comparison of the text modality with text stored in the products catalog in association with the one or more matches; storing the text modality of the search query in the products catalog in association with the one or more matches based on a determination that the novelty score is greater than a threshold value.

Aspect 31. The non-transitory computer readable storage medium of any one of the Aspects 19-36, wherein the first set of modalities includes image modality, the method further comprising: extracting embeddings, based on the neural network, of the image modality; and adding the embeddings of the image modality to pre-existing embeddings of other images associated with the one or more matches.

Aspect 32. The non-transitory computer readable storage medium of any one of the Aspects 19-36, wherein the first set of modalities includes a combination of image modality and text modality and wherein for the one or more matches, the products catalog includes a pre-existing single multi-modal embedding, the method further comprising: extracting text embeddings corresponding to the text modality and extracting image embeddings corresponding to the image modality, adding the text embeddings and the image embeddings to the pre-existing single multi-modal embeddings of associated with the one or more matches.

Aspect 33. The non-transitory computer readable storage medium of any one of the Aspects 19-36, wherein for the one or more matches, the products catalog includes a plurality of multi-modal embeddings, each multi-modal embedding of the plurality of multi-modal embedding representing a combination of a text embedding and an image embedding, wherein the first set of modalities includes text modality, the method further comprising: extracting text embeddings corresponding to the text modality; and adding the text embeddings to each multi-modal embedding of the plurality of multi-modal embeddings.

Aspect 34. The non-transitory computer readable storage medium of any one of the Aspects 19-36, wherein for the one or more matches, the products catalog includes a plurality of multi-modal embeddings, each multi-modal embedding of the plurality of multi-modal embedding representing a combination of a text embedding and an image embedding, wherein the first set of modalities includes image modality, the method further comprising: extracting image embeddings corresponding to the image modality; and generating a new multi-modal embedding by adding the image embeddings corresponding to the image modality to the text embedding.

Aspect 35. The non-transitory computer readable storage medium of any one of the Aspects 19-36, wherein for the one or more matches, the products catalog includes a plurality of separate image embeddings and text embeddings, wherein the first set of modalities includes text modality and image modality, the method further comprising: extracting image embeddings form the image modality and text embeddings form the text modality, storing the image embeddings form the image modality and the text embeddings from the text modality in association with the one or more matches in the products catalog.

Aspect 36. The non-transitory computer readable storage medium of any one of the Aspects 19-36, wherein receiving the indication that one or more of the matches from the products catalog is a confirmed match to the first search query includes receiving an indication of a weak confirmation that one or more of the matches from the products catalog is confirmed match to the first search query, the method further comprising: updating the one or more matches from the products catalog with at least one of the extracted embeddings and the first query search with a weak confirmation indicator.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

1. A method, comprising:
receiving a first search query associated with searching products, the first search query having a first set of modalities;
generating matches based on a cross-modal search using a machine learning model trained to search for matches in a products catalog that match the first search query, wherein matches in the products catalog have a second set of modalities;
receiving an indication that one or more of the matches from the products catalog is a confirmed match to the first search query;
responsive to receiving the indication, extracting embeddings, based on a neural network, of at least one modality of the first set of modalities of the first search query;
updating the one or more matches from the products catalog by generating at least one multi-modal embedding based on at least one of the extracted embeddings of the first search query and at least one embedding of at least one modality of the second set of modalities of the one or more matches, the updating the one or more matches including updating the one or more matches from the products catalog with the first search query;
receiving a second search query associated with searching products; and
generating matches based on a cross-modal search using the machine learning model trained to search for matches in the products catalog that has been updated with the at least one multi-modal embedding and the first search query.

2. The method of claim 1, wherein the first set of modalities includes a text modality and an image modality.

3. The method of claim 1, wherein the first set of modalities includes an image modality, and the second set of modalities includes a text modality, and wherein the extracting embeddings includes extracting embeddings of the image modality of the first search query.

4. The method of claim 1, wherein the first set of modalities and the second set of modalities are distinct.

5. The method of claim 1, wherein the first set of modalities includes text modality, the method further comprising:
annotating text of the first search query with structuring information related to the one or more matches in the product catalog prior to updating the one or more matches from the products catalog with the extracted embeddings.

6. The method of claim 1, wherein the first set of modalities includes image modality, the method further comprising:
segmenting, based on a neural network, portions of at least one image included in the first search query that include products; and
cropping the at least one image to segmented portions of the at least one image prior to extracting embeddings.

7. The method of claim 1, wherein the first set of modalities includes image modality, the method further comprising:
determining, using an image matching neural network, a similarity score for the image modality of the first search query with respect to each of a plurality of images associated with the one or more matches satisfies a criterion indicating that the image modality is dissimilar; and
storing the image modality of the first search query in the products catalog in association with the one or more matches.

8. The method of claim 1, wherein the first set of modalities includes image modality, the method further comprising:
determining that a quality measure based on at least one of image blur, image noise, or compression artifacts, of the image modality of the first search query satisfies a criterion; and
storing the image modality of the first search query in the products catalog in association with the one or more matches.

9. The method of claim 1, wherein the first set of modalities includes image modality, the method further comprising:
identifying a number of regions within an image associated with the image modality;
determining a first number of regions within the number of regions that include edges and a second number of regions within the number of regions that do not include edges;
storing the image modality of the first search query in the products catalog in association with the one or more matches based on a determination that a ratio of the first number of regions to the second number of regions is greater than a threshold value.

10. The method of claim 1, wherein the first set of modalities includes image modality, the method further comprising:
determining, based on image matching or cross-modal matching, a set of data, including texts or images, in the products catalog that is most similar to the image modality;
determining semantic similarities between members of the set of data;
determining at least one statistic including mean or standard deviation of the semantic similarities; and
storing the image modality of the first search query in the products catalog in association with the one or more matches based on a determination that the at least one statistic satisfies a criterion.

11. The method of claim 10, wherein the criterion is a function of a number of images in the products catalog associated with the one or more matches.

12. The method of claim 1, wherein the first set of modalities includes text modality, the method further comprising:
determining a novelty score for the text modality, the novelty score based on comparison of the text modality with text stored in the products catalog in association with the one or more matches;
storing the text modality of the first search query in the products catalog in association with the one or more matches based on a determination that the novelty score is greater than a threshold value.

13. The method of claim 1, wherein the first set of modalities includes image modality, the method further comprising:
extracting embeddings, based on the neural network, of the image modality; and
adding the embeddings of the image modality to pre-existing embeddings of other images associated with the one or more matches.

14. The method of claim 1, wherein the first set of modalities includes a combination of image modality and text modality and wherein for the one or more matches, the products catalog includes a pre-existing single multi-modal embedding, the method further comprising:
extracting text embeddings corresponding to the text modality and extracting image embeddings corresponding to the image modality; and
adding the text embeddings and the image embeddings to the pre-existing single multi-modal embeddings associated with the one or more matches.

15. The method of claim 1, wherein for the one or more matches, the products catalog includes a plurality of multi-modal embeddings, each multi-modal embedding of the plurality of multi-modal embeddings representing a combination of a text embedding and an image embedding, wherein the first set of modalities includes text modality, the method further comprising:
extracting text embeddings corresponding to the text modality; and
adding the text embeddings to each multi-modal embedding of the plurality of multi-modal embeddings.

16. The method of claim 1, wherein for the one or more matches, the products catalog includes a plurality of multi-modal embeddings, each multi-modal embedding of the plurality of multi-modal embedding representing a combination of a text embedding and an image embedding, wherein the first set of modalities includes image modality, the method further comprising:
extracting image embeddings corresponding to the image modality; and
generating a new multi-modal embedding by adding the image embeddings corresponding to the image modality to the text embedding.

17. The method of claim 1, wherein for the one or more matches, the products catalog includes a plurality of separate image embeddings and text embeddings, wherein the first set of modalities includes text modality and image modality, the method further comprising:
extracting image embeddings form the image modality and text embeddings from the text modality; and
storing the image embeddings from the image modality and the text embeddings from the text modality in association with the one or more matches in the products catalog.

18. The method of claim 1, wherein receiving the indication that one or more of the matches from the products catalog is a confirmed match to the first search query includes receiving an indication of a weak confirmation that one or more of the matches from the products catalog is a confirmed match to the first search query, the method further comprising:
updating the one or more matches from the products catalog with a weak confirmation indicator.

19. A non-transitory computer readable storage medium storing instructions, which when executed by one or more processors causes the one or more processors to execute a method, comprising:
receiving a first search query associated with searching products, the first search query having a first set of modalities;
generating matches based on a cross-modal search using a machine learning model trained to search for matches in a products catalog that match the first search query, wherein matches in the products catalog have a second set of modalities;
receiving an indication that one or more of the matches from the products catalog is a confirmed match to the first search query;
responsive to receiving the indication, extracting embeddings, based on a neural network, of at least one modality of the first set of modalities of the first search query;
updating the one or more matches from the products catalog by generating at least one multi-modal embedding based on at least one of the extracted embeddings of the first search query and at least one embedding of at least one modality of the second set of modalities of the one or more matches, the updating the one or more matches including updating the one or more matches from the products catalog with the first search query;
receiving a second search query associated with searching products; and
generating matches based on a cross-modal search using the machine learning model trained to search for matches in the products catalog that has been updated with the at least one multi-modal embedding and the first search query.

20. The non-transitory computer readable storage medium of claim 19, wherein the first set of modalities includes a text modality and an image modality.

21-36. (canceled)
